(19) United States
(12) Patent Application Publication
(10) Pub. No.: US 2026/0020560 A1
(43) Pub. Date: Jan. 22, 2026

(54) AGRICULTURAL METHYL DIHYDROJASMONATE COMPOSITIONS

(71) Applicant: Impello Biosciences, Inc., Fort Collins, CO (US)

(72) Inventors: Michael C. KEY, Fort Collins, CO (US); Michael J. DILEGGE, Fort Collins, CO (US)

(21) Appl. No.: 18/993,072

(22) PCT Filed: Jul. 14, 2023
(86) PCT No.: PCT/US2023/027838

§ 371 Date: Jan. 10, 2025

Related U.S. Application Data
(60) Provisional application No. 63/389,289, filed on Jul. 14, 2022.

(51) Int. Cl. A01N 37/42; A01N 25/30; A01N 59/26; A01N 65/03; A01P 15/00; A01P 21/00

(52) U.S. Cl. CPC A01N 37/42; A01N 25/30; A01N 59/26; A01N 65/03; A01P 15/00; A01P 21/00

(57) ABSTRACT

Disclosed are agricultural compositions comprising a jasmonate, a seaweed and a surfactant. Also disclosed are methods of using the compositions for altering secondary metabolite production in a plant or plant part.

### CROSS-REFERENCE TO RELATED APPLICATIONS

This application claims the benefit of U.S. Patent Application No. 63/389,289, filed Jul. 14, 2022, entitled “Agricultural Methyl Dihydrojasmonate Compositions,” the disclosure of which is hereby incorporated by reference in its entirety.

### FIELD OF THE DISCLOSURE

The present disclosure relates to agricultural compositions for use on Cannabis spp. plants and plant parts. The compositions comprise a jasmonate, seaweed, and a surfactant. Also disclosed are methods of using the compositions to modulate secondary metabolite production, including cannabinoid and terpene production, in Cannabis spp. plants and plant parts.

### BACKGROUND

Plants produce both primary (essential) and secondary (non-essential) metabolites during growth. Secondary metabolites are not necessary for the plant's survival but are small molecules that contribute to plant growth, development, defense, and reproductive capabilities. Numerous secondary metabolites, including alkaloids, terpenoids and isoprenoids, and phenolics, among others, have commercial value in industries ranging from nutraceuticals to pharmaceuticals to agrochemicals. Previously, cell suspensions and in vitro plant cultures have been modulated to induce the production of some plant derived secondary metabolites, but these applications have generally been limited to the large-scale production of plant products that are not adequately produced in planta.

Thus, there remains a need for compositions and methods of modulating production of secondary metabolites in planta.

### BRIEF SUMMARY

In one aspect, the present disclosure relates to an agricultural composition comprising: a jasmonate, an algae, and a surfactant. In some embodiments, the jasmonate is methyl dihydrojasmonate (“MDJ”). In some embodiments, the algae is kelp, e.g., Ascophyllum nodosum. In some embodiments, the composition further comprises at least one of nitrogen, phosphorous, potassium, and amino acids.

In another aspect, the present disclosure teaches a composition comprising methyl dihydrojasmonate, kelp, and a surfactant, wherein the weight ratio of the methyl dihydrojasmonate to the kelp is between about 1:1 and 1:5.

In another aspect, the present disclosure teaches a concentrated composition containing the same components and ratios of components as an agricultural composition disclosed herein, concentrated between about 1.1 and about 10,000 fold.

In another aspect, the present disclosure teaches a dilute composition containing the same components and ratios of components as an agricultural composition disclosed herein, diluted between about 1.1 and about 500 fold.

In another aspect, the present disclosure teaches a method for altering the production of one or more secondary metabolites in a Cannabis spp. plant or plant part, the method comprising: applying an effective amount of a composition disclosed herein.

In another aspect, the present disclosure teaches a method for altering the production of a terpene in a Cannabis spp. plant or plant part, the method comprising: applying an effective amount of a composition disclosed herein.

In another aspect, the present disclosure teaches a method for increasing a cannabinoid in a Cannabis spp. plant or plant part, the method comprising: applying an effective amount of a composition disclosed herein.

### BRIEF DESCRIPTION OF THE SEVERAL VIEWS OF THE DRAWINGS

The accompanying figures, which are incorporated herein and form a part of the specification, illustrate some, but not the only or exclusive, example embodiments and/or features. It is intended that the embodiments and figures disclosed herein are to be considered illustrative rather than limiting.

FIGS. 1A and 1B show the cannabinoid content in % by weight, averaged among hemp plants within the same treatment group, for CBDA (FIG. 1A) and Δ9-THCA (FIG. 1B). Asterisks indicate level of significance compared to negative control (“CK”): *, p<0.05; **, p<0.01; ***, p<0.001; ****, p<0.0001. Error bars correspond to standard error.

FIGS. 2A-2C show dry weight biomass averaged among plants in each treatment group in grams. FIG. 2A shows the aboveground dry weight biomass; FIG. 2B shows the belowground dry weight biomass; and FIG. 2C shows the total dry weight biomass.

FIGS. 3A-3E show images of exemplary plants from different treatment groups. FIG. 3A shows a view of the aerial biomass of plants from each group. FIG. 3B shows a view of the aerial biomass for plants treated with Formula A, B, and C. FIG. 3C shows a view of the aerial biomass for plants treated with Formula D, Formula E, negative control (“Ck”), and positive control (“R”). FIG. 3D shows a closer view of the leaves of plants treated with Formula A, B, and C. FIG. 3E shows a closer view of the leaves of plants treated with Formula D, Formula E, negative control (“Ck”), and positive control (“R”).

FIG. 4 shows a bar graph of total THC averages for plants treated with the composition of the present disclosure compared to plants treated with a competitor product and water only control.

FIGS. 5A and 5B show bar graphs of various cannabinoids (FIG. 5A) and terpenes (FIG. 5B) for plants treated with the composition of the present disclosure compared to plants given water only (control).

### DETAILED DESCRIPTION

The following description includes information that may be useful in understanding the present disclosure. It is not an admission that any of the information provided herein is prior art or relevant to the presently claimed disclosures, or that any publication specifically or implicitly referenced is prior art. All ranges disclosed in embodiments herein expressly include the end points of the range and all intervening values.

### Definitions

The term “a” or “an” refers to one or more of that entity, i.e. can refer to plural referents. As such, the terms “a,” “an,” “one or more,” and “at least one” are used interchangeably herein. In addition, reference to “an element” by the indefinite article “a” or “an” does not exclude the possibility that more than one of the elements is present, unless the context clearly requires that there is one and only one of the elements.

Throughout this application, the term “about” is used to indicate that a value includes the inherent variation of error for the device or the method being employed to determine the value, or the variation that exists among the samples being measured. Unless otherwise stated or otherwise evident from the context, the term “about” means within 10% above or below the reported numerical value (except where such number would exceed 100% of a possible value or go below 0%). When used in conjunction with a range or series of values, the term “about” applies to the endpoints of the range or each of the values enumerated in the series, unless otherwise indicated. As used in this application, the terms “about” and “approximately” are used as equivalents.

The International Code of Zoological Nomenclature defines rank, in the nomenclatural sense, as the level, for nomenclatural purposes, of a taxon in a taxonomic hierarchy (e.g., all families are for nomenclatural purposes at the same rank, which lies between superfamily and subfamily). While somewhat arbitrary, there are seven main ranks defined by the international nomenclature codes: kingdom, phylum/division, class, order, family, genus, and species

As used herein, the terms “jasmonate” or “jasmonates” refer to a class of compounds modulating plant responses to abiotic and biotic stimuli. The compounds may be produced endogenously in a plant, exogenously applied to a plant, or of synthetic origin, and include ethyl jasmonate, jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and their homologues or analogues, isomers, derivatives or conjugates thereof.

As used herein, a “high-CBD” cannabis line refers to a cannabis variety capable of accumulated at least 5% CBDmax by weight in the trimmed dried inflorescence. Thus, a “low-CBD” cannabis line would exhibit less than 5% by weight in the trimmed dried inflorescence.

As used herein, “marijuana” refers to a cannabis variety having greater than 0.3% THC. A marijuana variety capable of accumulating greater than 10% THCmax by weight in the trimmed dried inflorescence is herein referred to as a “high-THC” variety.

As used herein, “hemp” refers to a cannabis variety having less than 0.3% THC.

As used herein, “altering” or “altered” may refer to an increase or decrease relative to a control value.

As used herein, the term “seaweed” refers to any species of marine macroalgae for use in agricultural compositions. In some embodiments, seaweed is brown seaweed. In some embodiments, it is kelp. In some embodiments, the seaweed is in a digested or powdered form suitable for resuspension in a liquid medium.

As used herein, an “effective amount” refers to an amount of a composition or a component thereof that is sufficient to produce the intended effect. In some embodiments, an “effective amount” of an agricultural composition is an amount effective to alter the production of a cannabinoid or a terpene in a Cannabis spp. plant or plant part. In some embodiments, an “effective amount” of a jasmonate and a seaweed within an agricultural composition is an amount effective to alter the production of a cannabinoid or a terpene in a Cannabis spp. plant or plant part.

As used herein, “total THC” equals THC+(THCA*(0.877)), and is expressed as a percentage of mg/g dry weight.

Embodiments of the present disclosure define compositions based on their % content. In some embodiments the % content is (v/v), which is calculated based on the volume of the recited ingredient divided by the volume of the composition. In some embodiments the % content is (w/v), which is calculated based on the weight (in grams) of the recited ingredient divided by the volume (in liter) of the composition. In some embodiments the % content is (w/w), which is calculated based on the weight of the recited ingredient divided by the weight of the composition.

### Agricultural Compositions of the Disclosure

The present disclosure relates to agricultural compositions for altering production of a secondary metabolite in a Cannabis spp. plant or plant part. The compositions comprise a jasmonate, an algae, and a surfactant. In some embodiments, the compositions comprise phosphorous, potassium, amino acids, chelators, and/or nitrogen.

### Jasmonates

Certain biochemicals are known to function endogenously within the plant and play roles within plant hormone signal transduction. Jasmonic Acid (JA) and Salicylic Acid (SA), which correspond to the Jasmonic Acid pathway and Salicylic Acid pathway in higher plants are responsible for modulating plant responses to abiotic and biotic stimuli. These biosynthetic pathways derive from alpha-linolenic acid metabolism and phenylalanine metabolism, respectively, and in some plant species are antagonists of each other; when JA pathways are upregulated, SA pathways are repressed, and vice versa. This phenomenon can be described in one sense by the chemical's relationship to the octadecanoid pathway, which is responsible for the production of jasmonic acid. Salicylates demonstrate negative crosstalk with jasmonates and likewise are considered inhibitors of the octadecanoid pathway.

Jasmonic acid is one of several endogenous lipid-based octadecanoid derivatives that are known to act as elicitors of plant defense, along with its methyl ester (methyl jasmonate, MeJA) and other derivatives (Saniewski M. (1997) The Role of Jasmonates in Ethylene Biosynthesis. In: Kanellis A. K., Chang C., Kende H., Grierson D. (eds) Biology and Biotechnology of the Plant Hormone Ethylene. NATO ASI Series (3. High Technology), vol 34). Jasmonates generally follow the same fundamental biosynthetic steps in plants, starting with the oxygenation of alpha-linolenic acid by lipoxygenase (13-LOX), which cyclizes to form allene oxide and then rearranges to form 12-oxophytodienoic acid (12-OPDA), which is then transformed into 7-iso-jasmonic acid via R-oxidations and can isomerize into JA. JA can then decarboxylate into the bioactive cis-jasmone (CJ), conjugate with isoleucine to produce JA-lle, or be metabolized into Methyl Jasmonate (MeJA), among others (Matsui, R., et al. Elucidation of the biosynthetic pathway of cis-jasmone in Lasiodiplodia theobromae. Sci Rep 7, 6688 (2017)).

Jasmonate derivatives, or derivatives of the octadecanoid pathway comprised of a cyclopentanone ring, cyclopentene ring, or other ketone may include an alkane chain or an alkene chain, or may include a different hydrocarbon chain and may include a carboxylic acid side chain of different lengths.

Shown below is the structure for Methyl Jasmonate (MeJA) (from National Center for Biotechnology Information (2021). PubChem Compound Summary for CID 5281929, Methyl jasmonate).

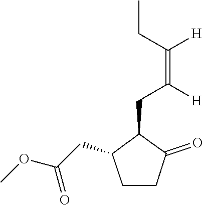 [SMILES: CC/C=C\C[C@H]1C(=O)CC[C@@H]1CC(=O)OC]

Shown below is the structure for methyl dihydrojasmonate (MDJ) (National Center for Biotechnology Information (2021). PubChem Compound Summary for CID 102861, Methyl dihydrojasmonate).

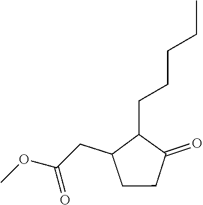 [SMILES: CCCCCC1C(=O)CCC1CC(=O)OC]

Shown below is the structure for cis-jasmone (CJ) (National Center for Biotechnology Information (2021). PubChem Compound Summary for CID 1549018, Jasmone).

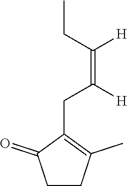

All jasmonates and even jasmonate-like molecules, including (+)-cucurbic acid and tuberonic acid, share some similarities in their chemical structures, such as cyclopentanone rings. However specific jasmonate-type responses in plants may be structure dependent and based on the presence of hydroxyl groups, methyl groups, hydrocarbon chains, carboxylic acid chains, or other functional groups, or may be dependent on the chirality of each jasmonate type compound, or may be dependent on the compound's stereoisomerism, or may be dependent on the compound's spatial isomerism, or otherwise dependent on the structure.

Prohydrojasmone (PDJ) is a synthetic derivative of jasmonic acid previously shown to increase anthocyanain and bring about the red color in apples (BLUSH™). Methyl dihydrojasmonate is only produced endogenously in a few plants, thus its ability to function as an elicitor was previously unresearched. Additionally, jasmonate derivatives like cis-jasmone (CJ) may be used to elicit more specific responses when applied exogenously in planta in comparison to the standard jasmonate elicitors like JA and MeJA.

In some embodiments, the present disclosure teaches compositions comprising an effective amount of at least one jasmonate. In some embodiments, the at least jasomonate is selected from the group consisting of methyl jasmonate, jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and their homologues or analogues, isomers, derivatives or conjugates thereof. In some aspects, the composition comprises methyl jasmonate. In some aspects, the composition comprises methyl dihydrojasmonate. In some aspects, the composition comprises cis-jasmone.

In some aspects, the compositions comprise two jasmonates. In some aspects, the two jasmonates are methyl jasmonate and methyl dihydrojasmonate. In some aspects, the two jasmonates are methyl jasmonate and cis-jasmone. In some aspects, the two jasmonates are methyl dihydrojasmonate and cis-jasmone. In some aspects, the composition comprises three jasmonates. In some aspects, the three jasmonates are methyl jasmonate, methyl dihydrojasmonate, and cis-jasmone.

### Algae

The compositions of the present disclosure comprise an algae. In some embodiments, the algae is a macroalgae. In some embodiments, the algae is microalgae.

In some embodiments, the algae is a brown seaweed. In some embodiments, the seaweed is a kelp.

In some embodiments, the algae is of a genera selected from one of the following: Ascophyllum, Durvillaea, Ecklonia, Fucus, Gracilaria, Kappaphycus, Laminaria, Macrocystis, and Sargassum. In some embodiments, the algae is of a species selected from one of the following: Ascophyllum nodosum, Durvillaea potatorum, Ecklonia bicyclis, Ecklonia arborea, Ecklonia cava, Ecklonia kurome, Ecklonia maxima, Ecklonia radiate, Ecklonia stoloifera, Fucus vesiculosus, Fucus serratus, Fucus gardneri, Gracilaria canaliculata, Gracilaria edulis, Gracilaria preissiana, Gracilaria textorii, Gracilaria corticata, Gracilaria folifera, Gracilaria verrucosa, Kappaphycus alvarezii, Laminaria digitata, Laminaria longicruris, Laminaria saccharina, Laminaria sinclairii, Macrocystis pyrifera, Sargassum fusiforme, Sargassum tenerrimum, Sargassum wightii, Sargassum cinctum, Sargassum cinereum, Sargassum crassifolium, Sargassum glaucescens, Sargassum ilicifolium, Sargassum plagiophyllum, Sargassum polycystum, Sargassum prismaticum, Sargassum swartzii, Sargassum tenerrimum, and Sargassum vulgare. In some embodiments, the algae is Ascophyllum nodosum.

In some embodiments, the algae is of any one of the genera or species recited in U.S. Pat. Nos. 10,555,536, 10,492,489, or 11,286,212, each of which is incorporated by reference herein.

In some embodiments, the algae is comprised in the composition in a digested liquid form on in a powdered form. In some embodiments, the algae is resuspended in liquid prior to addition to the composition. In some embodiments, macro particulates are strained out of the resuspended algae prior to inclusion in the agricultural composition.

### Surfactant

The compositions of the disclosure comprise a surfactant. By the term “surfactant” it is understood that wetting agents, surface-active agents or surfactants, dispersing agents, suspending agents, emulsifying agents, and combinations thereof, are included therein. In some embodiments, ionic surface-active agents are used. In some embodiments, non-ionic surface-active agents are used.

Examples of non-ionic surface-active agents include, but are not limited to, alkoxylates, N-substituted fatty acid amides, amine oxides, esters, sugar-based surfactants, polymeric surfactants, and mixtures thereof, allinol, nonoxynol, octoxynol, oxycastrol, oxysorbic (for example, polyoxyethylated sorbitol fatty-acid esters, thalestol, and polyethylene glycol octylphenol ether (TRITON®). In some embodiments, the surfactant is polysorbate-20. In some embodiments, the surfactant is Sorbitan monooleate.

Examples of ionic surfactants for use with the compositions described herein may include anionic surfac-tants such as alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignin sul-fonates, sulfonates of fatty acids and oils, sulfonates of ethoxylated alkylphenols, sulfonates of alkoxylated arylphe-nols, sulfonates of condensed naphthalenes, sulfonates of dodecyl- and tridecylbenzenes, sulfonates of naphthalenes and alkylnaphthalenes, sulfosuccinates or sulfosuccina-mates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl car-boxylates, and carboxylated alcohol or alkylphenol ethoxy-lates.

Persons having skill in the art will be able to formulate the compositions of the present disclosure with appropriate surfactants to allow for plant applications. In some embodiments, the amount of surfactant used is the minimum amount required to get the compound into solution/emulsion, and will generally be 0.1 to 5% by weight.

### Additional Ingredients

In some embodiments, the composition comprises a chelator. In some embodiments, the chelator is fulvic acid. The carbon-based structure of fulvic acid binds with inorganic minerals to create organic acid complexes that are readily bioavailable for uptake by plants and other life-forms (biochemically active and recognizable nutrients). In addition to its role as a nutrient chelator, fulvic acid also assists with cellular metabolism, restores electrical balance as an electrolyte, scavenges free radicals as an antioxidant, buffers pH, removes heavy metals and binds radioactive substances into neutral molecules. In some embodiments, the composition comprises humic acid.

In some embodiments, the composition comprises potassium. In some embodiments, the composition comprises monopotassium phosphate. In some embodiments, the composition comprises dipotassium phosphate. In some embodiments, the composition comprises KOH. In some embodiments, the composition comprises phosphorous.

In some embodiments, the composition comprises nitrogen. In some embodiments, the composition comprises a nitrogenous fertilizer. In some embodiments, the composition comprises urea, nitrates, ammonia, and/or water-soluble nitrogen.

In some embodiments, the composition comprises amino acids. Amino acid fertilizers are manufactured either by hydrolysis or enzymatic treatment of proteins. In some embodiments, the proteins are from plants. In some embodiments, the proteins are from animals. In some embodiments, the proteins are from algae. Amino acid fertilizers are readily absorbed, transported, and utilized as a source of nitrogen and carbon for plants. This saves the energy expended by the plant to reduce organic matter, synthetic nitrates and ammonia into amino acids. Some amino acids are efficient metal ion chelators which can help with metal ion nutrient uptake and help protect plants from toxic levels of metal ions. Amino acids also function as biostimulants for plants. As a biostimulant, amino acids can play important roles in enhancing plant productivity, especially under abiotic and biotic stress conditions.

### Buffering Agents

In some embodiments, the compositions disclosed herein comprise a chemical buffer or buffering agent. The buffering agent prevents fluctuations in the pH of the composition.

In some embodiments, the chemical buffer maintains the pH of the composition in the pH range of pH 5-9, pH 5-8, pH 5-7, pH 5-6, pH 6-9, pH 6-8, pH 6-7, pH 7-9, or pH 7-8. In some aspects, the chemical buffer maintains the composition at a neutral pH. In some aspects, the chemical buffer comprises potassium phosphate. In some embodiments, the chemical buffer is monopotassium phosphate (KH₂PO₄). In some embodiments, the chemical buffer is dipotassium phosphate (K₂HPO₄). In some embodiments, the chemical buffer is a mixture of monopotassium phosphate (KH₂PO₄) and dipotassium phosphate (K₂HPO₄).

One skilled in the art will appreciate that, in some embodiments, other chemical buffers capable of maintaining a neutral or approximately neutral pH may be used.

Non-limiting examples of buffering agents include potassium phosphates, sodium citrate, ascorbate, succinate, lactate, citric acid, boric acid, borax, hydrochloric acid, disodium hydrogen phosphate, acetic acid, formic acid, glycine, bicarbonate, phosphate, tartaric acid, Tris-glycine, Tris-NaCl, Tris-ethylenediamine tetraacetic acid (“EDTA”), Tris-borate, Tris-borate-EDTA, Tris-acteate-EDTA (“TAB”), Tris-buffered saline, 4-(2-hydroxyethyl)-1-piperazineethanesulfonic acid (“HEPES”), 3-(N-morpholino) propanesulfonic acid (“MOPS”), piperazine-1,4-bis(2-ethanesulfonic acid) (“PIPES”), 2-(N-morpholino)ethanesulfonic acid (“MES”), and phosphate buffered saline (“PBS”). Table 1 also provides exemplary buffering agents as well as their pKa values and useful pH ranges.

TABLE 1
Exemplary buffering agents

| | pKa at | Useful pH |
|---|---|---|
| Common name and/or chemical name | 25° C. | range |
| ACES | 6.78 | 6.1-7.5 |
| Acetic acid (Ethanoic acid) | 4.8 | 3.8-5.8 |
| ADA | 6.59 | 6.0-7.2 |
| AMP | 9.7 | 9.0-10.5 |
| AMPD | 8.8 | 7.8-9.7 |
| AMPSO | 9 | 8.3-9.7 |
| BES | 7.09 | 6.4-7.8 |
| Bicine (2-(bis(2-hydroxyethyl)amino)acetic | 8.35 | 7.6-9.0 |
| acid) | | |
| Bis-Tris | 6.5 | 5.8-7.2 |
| Bis-Tris Propane | 6.8, 9.0 | 6.3-9.5 |
| Boric acid | 9.24 | 8.25-10.25 |
| CABS | 10.7 | 10.0-11.4 |
| Cacodylate (dimethylarsenic acid) | 6.27 | 5.0-7.4 |
| CAPS | 10.4 | 9.7-11.1 |
| CAPSO | 9.6 | 8.9-10.3 |
| CHES (N-Cyclohexyl-2-aminoethanesulfonic | 9.3 | 8.3-10.3 |
| acid) | | |
| Citric acid (2-Hydroxypropane-1,2,3- | 3.13, 4.76, | 2.1-7.4 |
| tricarboxylic acid) | 6.40 | |
| DIPSO | 7.6 | 7.0-8.2 |
| EPPS | 8 | 7.3-8.7 |
| Gly-Gly | 8.2 | 7.5-8.9 |
| HEPBS | 8.3 | 7.6-9.0 |
| HEPES (4-(2-hydroxyethyl)-1- | 7.48 | 2.5-3.5 or |
| piperazineethanesulfonic acid) | | 6.8-8.2 |
| HEPPSO | 7.8 | 7.1-8.5 |
| KH₂PO₄ (Monopotassium phosphate) | 7.2 | 6.2-8.2 |
| K₂HPO₄, | 12.4 | 8.7-9.4 |
| K₃PO₄ | | 11.5-12.3 |
| MES (2-(N-morpholino)ethanesulfonic acid) | 6.15 | 5.5-6.7 |
| MOBS | 7.6 | 6.9-8.3 |
| MOPS (3-(N-morpholino)propanesulfonic acid) | 7.2 | 6.5-7.9 |
| MOPSO | 6.9 | 6.2-7.6 |
| PBS or high buffering capacity PBS | | 5.8-8.0 |
| PIPES | 6.76 | 6.1-7.5 |
| PIPES (piperazine-N,N′-bis(2-ethanesulfonic | 6.76 | 6.1-7.5 |
| acid)) | | |
| POPSO | 7.8 | 7.2-8.5 |
| TABS | 8.9 | 8.2-9.6 |
| TAPS ([tris(hydroxymethyl)methyl- | 8.43 | 7.7-9.1 |
| amino]propanesulfonic acid) | | |
| TAPSO (3-[N-tris(hydroxymethyl)methyl- | 7.635 | 7.0-8.2 |
| amino]-2-hydroxypropanesulfonic acid) | | |
| TEA | 7.8 | 7.3-8.3 |
| TES (2-[[1,3-dihydroxy-2- | 7.4 | 6.8-8.2 |
| (hydroxymethyl)propan-2- | | |
| yl]amino]ethanesulfonic acid) | | |
| Tricine (N-[tris(hydroxymethyl)methyl]glycine) | 8.05 | 7.4-8.8 |
| Tris (tris(hydroxymethyl)aminomethane) or (2- | 8.07 | 7.1-9.1 |
| amino-2-(hydroxymethyl)propane-1,3-diol) | | |

Additional buffers and instructions on how to prepare them can be found in, e.g., “Common Buffers and Stock Solutions” (2011) Current Protocols in Nucleic Acid Chemistry, A.2A.1-A.2A.14 and in the Sigma Aldrich “Buffer Reference Center” available on the world wide web at sigmaaldrich.com/life-science/core-bioreagents/biological-buffers/learning-center/buffer-reference-center.html, the contents of each of which are incorporated herein in their entirety. Persons having skill in the art will appreciate that the amount of buffer needed to maintain the desired pH will depend on the buffer used, and the total volume of solution.

### Additives

In some embodiments, the compositions disclosed herein further comprise additives, auxiliaries, and/or excipients. Additional components may act to improve the stability of the composition, improve the homogeneity of the composition, improve the function of the composition in planta, or provide other qualities to the composition and/or to the methodology of the present disclosure. In some embodiments, the composition further comprises amino acids, minerals, salts, solvents, stabilizers, growth regulators, hormones, enzymes, vitamins, chitin, chitosan, carboxylic acids, carboxylic acid derivatives, linoleic acid and other fatty acids, volatile organic compounds (VOCs), microbial consortia or isolates, bioregulators, biostimulants, and other additives known in the art to elicit a biological, biochemical, physiological, and/or physiochemical response from the plant, or to stabilize the composition, or to elicit specific metabolite production in the plant.

In some embodiments, the compositions disclosed herein may be mixed with one or more auxiliaries, adjuvants, excipients, surfactants, or other chemicals. Compositions may be applied simultaneously but separately from plant growth inputs, like nutrients and pesticides, for improved performance or facility.

### Exemplary Formulations

Provided herein are exemplary formulations, ratios, concentrations, and molarities of components in illustrative agricultural compositions of the disclosure. These ranges are intended to illustrate, but not to limit, the disclosed compositions.

The compositions disclosed herein include liquid and/or dry forms and include dry stock components that are added to water or other liquids prior to application to the plant in an aqueous form. Liquid compositions include aqueous, polar, or non-polar solutions. The compositions may comprise an oil-in-water emulsion or a water-in-oil emulsion. In some embodiments, the composition is diluted. In some embodiments the composition is concentrated. In some embodiments the composition is aqueous.

### Ratios of Components in Composition

In some embodiments, the weight ratio of jasmonate to algae in the composition is between about 1:20 (w/w) and about 20:1 (w/w). In some embodiments, the weight ratio of jasmonate to seaweed in the composition is between about 1:10 (w/w) and about 10:1 (w/w). In some embodiments, the weight ratio of jasmonate to algae in the composition is about 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, or 10:1 (w/w). In some embodiments, the weight ratio of jasmonate to algae in the composition is about 1:1 (w/w). In some embodiments, the weight ratio of jasmonate to algae in the composition is between about 1:1 and about 1:2 (w/w). In some embodiments, the weight ratio of jasmonate to seaweed in the composition is about 5:1 (w/w). In some embodiments, the jasmonate is MDJ. In some embodiments, the algae is kelp.

In some embodiments, the weight ratio of jasmonate to surfactant in the composition is between about 1:10 (w/w) and about 10:1 (w/w). In some embodiments, the weight ratio of jasmonate to surfactant in the composition is about 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, or 10:1 (w/w). In some embodiments, the weight ratio of jasmonate to surfactant in the composition is about 1:2.5. In some embodiments, the jasmonate is MDJ. In some embodiments, the surfactant is polysorbate-20.

In some embodiments, the weight ratio of jasmonate to algae in the composition is between about 1:10 (w/w) and about 10:1 (w/w), and the weight ratio of jasmonate to surfactant in the composition is between about 1:10 (w/w) and about 10:1 (w/w). In some embodiments, the weight ratio of jasmonate to algae in the composition is between about 1:2 (w/w) and about 5:1 (w/w), and the weight ratio of jasmonate to surfactant in the composition is about 1:2.5 (w/w).

In some embodiments, the weight ratio of MDJ to algae, e.g., kelp, in the composition is between about 1:10 (w/w) and about 10:1 (w/w), and the weight ratio of MDJ to surfactant, e.g., polysorbate-20, in the composition is between about 1:10 (w/w) and about 10:1 (w/w). In some embodiments, the weight ratio of MDJ to algae, e.g., kelp, in the composition is between about 1:2 (w/w) and about 5:1 (w/w), and the weight ratio of MDJ to surfactant, e.g., polysorbate-20, in the composition is about 1:2.5 (w/w).

### Level of Dilution or Concentration of Composition

Expressly provided herein are compositions at any level of concentration and/or dilution that maintain the ratios of components disclosed herein.

In some embodiments, the composition is prepared as a fully diluted ready-to-apply composition. In some embodiments, the composition is prepared as a concentrate for agricultural application after dilution. In some embodiments, the composition is concentrated 2-fold to 10,000-fold. In some embodiments, the composition is concentrated about 50, 100, 150, 200, 250, 300, 350, 400, 450, 500, 550, 600, 650, 700, 750, 800, 850, 900, 950, or 1000-fold. In some embodiments, the composition is concentrated about 500, 1000, 1500, 2000, 2500, 3000, 3500, 4000, 4500, or 4500-fold. In some embodiments, the composition is concentrated about 5000, 5500, 6000, 6500, 7000, 7500, 8000, 8500, 9000, 9500, or 10,000-fold. The degree of concentration also depends on the concentration applied to plants. In some embodiments, a composition is applied at a lower, standard, or higher rate depending on desired results and the watering needs of the plant. In some embodiments, the composition is concentrated about 378-fold compared to the standard rate intended for application to plants, i.e., the fold concentration for 10 mL into 1 gallon dilution prior to application.

### Exemplary Component Ranges in Illustrative Ready-to-Apply Composition

The following exemplary concentrations are provided to illustrate an embodiment of the invention at a ready-to-apply concentration. As will be appreciated by a person of skill in the art, the individual amounts of each component will vary depending on the level of concentration in the composition, but the relative ratios of components would be maintained at any fold-level of concentration or dilution. In some embodiments, the ready-to-apply composition is applied at a rate of between 0.5 mL/gal and 40 mL/gal.

In some embodiments, the ready-to-apply composition comprises about 0.1-100 μM jasmonate. In some embodiments, the ready-to-apply composition comprises about 0.1-50 μM jasmonate. In some embodiments, the ready-to-apply composition comprises about 0.1-25 μM jasmonate. In some embodiments, the ready-to-apply composition comprises about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 μM jasmonate. In some embodiments, the ready-to-apply composition comprises about 2.5 μM jasmonate. In some embodiments, the ready-to-apply composition comprises between 4 μM and 5 μM jasmonate. In some embodiments, the ready-to-apply composition comprises about 15 μM jasmonate. In some embodiments, the ready-to-apply composition comprises about 25 μM jasmonate.

In some embodiments, the jasmonate is MDJ. In some embodiments, the ready-to-apply composition comprises about 0.1-100 μM MDJ. In some embodiments, the ready-to-apply composition comprises about 0.1-50 μM MDJ. In some embodiments, the ready-to-apply composition comprises about 0.1-25 μM MDJ. In some embodiments, the ready-to-apply composition comprises about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 μM MDJ. In some embodiments, the ready-to-apply composition comprises between 4 μM and 5 μM MDJ. In some embodiments, the ready-to-apply composition comprises about 15 μM MDJ. In some embodiments, the ready-to-apply composition comprises about 2.5 μM MDJ. In some embodiments, the ready-to-apply composition comprises about 25 μM MDJ.

In some embodiments, the ready-to-apply composition comprises about 0.05 mg/L to about 25 mg/L algae. In some embodiments, the ready-to-apply composition comprises about 0.05 mg/L to about 3 mg/L algae. In some embodiments, the ready-to-apply composition comprises about 0.05, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 mg/L algae. In some embodiments, the ready-to-apply composition comprises about 1.2 mg/L algae. In some embodiments, the algae is kelp.

In some embodiments, algae is Ascophyllum nodosum. In some embodiments, the ready-to-apply composition comprises about 0.05 mg/L to about 25 mg/L Ascophyllum nodosum. In some embodiments, the ready-to-apply composition comprises about 0.05 mg/L to about 3 mg/L Ascophyllum nodosum. In some embodiments, the ready-to-apply composition comprises about 0.05, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 mg/L Ascophyllum nodosum.

In some embodiments, the ready-to-apply composition comprises about 1.2 mg/L Ascophyllum nodosum.

In some embodiments, the ready-to-apply composition comprises about 0.1 nM to about 100 μM surfactant. In some embodiments, the ready-to-apply composition comprises about 0.5 μM to about 20 μM surfactant. In some embodiments, the ready-to-apply composition comprises about 0.5, 0.6, 0.7, 0.8, 0.9, 1, 2, 3, 4, 5, 6, 7, 8, 9, 10, 11, 12, 13, 14, 15, 16, 17, 18, 19, or 20 μM surfactant. In some embodiments, the ready-to-apply composition comprises about 1 μM surfactant. In some embodiments, the ready-to-apply composition comprises about 10 μM surfactant. In some embodiments, the surfactant is polysorbate-20. In some embodiments, the surfactant is Sorbitan monooleate.

In some embodiments, the composition comprises potassium. In some embodiments, the ready-to-apply composition comprises between about 0.1 mM and 50 mM potassium. In some embodiments, the ready-to-apply composition comprises about 1-10 mM potassium. In some embodiments, the ready-to-apply composition comprises about 0.1, 0.2, 0.3, 0.4, 0.5, 0.6, 0.7, 0.8, 0.9, 1, 2, 3, 4, 5, 6, 7, 8, 9, or 10 mM potassium. In some embodiments, the ready-to-apply composition comprises about 5 mM potassium.

In some embodiments, the composition comprises phosphorous. In some embodiments, the ready-to-apply composition comprises about 0.1-20 mM phosphorous. In some embodiments, the ready-to-apply composition comprises about 0.5-5 mM phosphorous. In some embodiments, the ready-to-apply composition comprises about 0.5, 1, 1.5, 2, 2.5, 3, 3.5, 4, 4.5, or 5 mM phosphorous. In some embodiments, the ready-to-apply composition comprises about 2.5 mM phosphorous.

In some embodiments, the composition comprises amino acids in addition to those comprised by the kelp. In some embodiments, the ready-to-apply composition comprises between about 0.00001% and 0.01% amino acids by weight in addition to those comprised by the algae. In some embodiments, the ready-to-apply composition comprises about 1e-4% to about 1e-3% amino acids by weight in addition to those comprised by the algae. In some embodiments, the ready-to-apply composition comprises about 1e-4, 2e-4, 3e-4, 4e-4, 5e-4, 6e-4, 7e-4, 8e-4, 9e-4, or 1e-3% amino acids by weight in addition to those comprised by the algae.

In some embodiments, the ready-to-apply composition comprises about 4e-4% amino acids by weight in addition to those comprised by the algae.

In some embodiments, the composition comprises polypeptides. In some embodiments, the ready-to-apply composition comprises about 2%, about 1.9%, about 1.8%, about 1.7%, about 1.6%, about 1.5%, about 1.4%, about 1.3%, about 1.2%, about 1.1%, about 1%, about 0.9%, about 0.8%, about 0.7%, about 0.6%, about 0.5%, about 0.4%, about 0.3%, about 0.2% or about 0.1% by weight. In some embodiments, the ready-to-apply composition comprises less than 2% (w/v) polypeptides. In some embodiments, the ready-to-apply composition comprises less than 1% (w/v) polypeptides.

In some embodiments, the composition comprises nitrogen. In some embodiments, the ready-to-apply composition comprises about 0.1 μM to about 100 μM nitrogen. In some embodiments, the ready-to-apply composition comprises between about 0.1 μM and 5 μM nitrogen. In some embodiments, the ready-to-apply composition comprises about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 μM nitrogen. In some embodiments, the ready-to-apply composition comprises between about 5 μM and 6 μM nitrogen. In some embodiments, the ready-to-apply composition comprises about 22 μM nitrogen.

In some embodiments, the composition comprises fulvic acid. In some embodiments, the amount of fulvic acid in the composition is quantified based on the hydrophobic fulvic acid. In some embodiments, the ready-to-apply composition comprises about 1e-7% to about 1e-4% hydrophobic fulvic acid by weight. In some embodiments, the ready-to-apply composition comprises about 5e-6% to about 3e-5% hydrophobic fulvic acid by weight. In some embodiments, the ready-to-apply composition comprises about 5e-6, 6e-6, 7e-6, 8e-6, 9e-6, 1.0e-5, 1.1e-5, 1.2e-5, 1.3e-5, 1.4e-5, 1.5e-5, 1.6e-5, 1.7e-5, 1.8e-5, 1.9e-5, 2.0e-5, 2.1e-5, 2.2e-5, 2.3e-5, 2.4e-5, 2.5e-5, 2.6e-5, 2.7e-5, 2.8e-5, 2.9e-5, or 3.0e-5% hydrophobic fulvic acid by weight. In some embodiments, the ready-to-apply composition comprises about 1.6e-5% hydrophobic fulvic acid by weight.

In some embodiments, the ready-to-apply composition comprises about 0.1-50 μM methyl dihydrojasmonate; about 0.05 mg/L to about 5 mg/L algae; and about 0.5 μM to about 20 μM surfactant.

In some embodiments, the ready-to-apply composition comprises about 0.1-50 μM jasmonate, e.g., MDJ; about 0.05 mg/L to about 5 mg/L algae, e.g., kelp; about 0.5 μM to about 20 μM surfactant, e.g., polysorbate-20; about 1-10 mM potassium; about 0.5-5 mM phosphorous; about 1e-4% to about 1e-3% amino acids by weight in addition to those comprised by the kelp; and about 5e-6% to about 3e-5% hydrophobic fulvic acid by weight.

In some embodiments, the ready-to-apply composition comprises about 0.1-50 μM jasmonate, e.g., MDJ; about 0.05 mg/L to about 5 mg/L algae, e.g., kelp; about 0.5 μM to about 20 μM surfactant, e.g., polysorbate-20; about 1-10 mM potassium; about 0.5-5 mM phosphorous; about 1e-4% to about 1e-3% amino acids by weight in addition to those comprised by the kelp; about 5e-6% to about 3e-5% hydrophobic fulvic acid by weight; and about 5 μM to about 50 μM nitrogen.

### Exemplary Component Ranges in Illustrative 378-Fold Concentrated Composition

The following exemplary concentrations are provided to illustrate an embodiment of the invention concentrated about 378-fold compared to the standard rate intended for application to plants; i.e., concentrated for a dilution of 10 mL of composition into 1 gallon of water prior to application. As will be appreciated by a person of skill in the art, the individual amounts of each component will vary depending on the level of concentration in the concentrated composition, but the relative ratios of components would be maintained at any fold-level of concentration or dilution.

In some embodiments, the composition comprises about 0.1-100 mM jasmonate. In some embodiments, the composition comprises about 0.5-20 mM jasmonate. In some embodiments, the composition comprises about 0.5 mM, 1 mM, 2 mM, 3 mM, 4 mM, 5 mM, 6 mM, 7 mM, 8 mM, 9 mM, 10 mM, 11 mM, 12 mM, 13 mM, 14 mM, 15 mM, 16 mM, 17 mM, 18 mM, 19 mM, or 20 mM jasmonate. In some embodiments, the composition comprises about 1 mM jasmonate. In some embodiments, the composition comprises about 10 mM jasmonate.

In some embodiments, the jasmonate is MDJ. In some embodiments, the composition comprises about 0.1-100 mM MDJ. In some embodiments, the composition comprises about 0.5-20 mM MDJ. In some embodiments, the composition comprises about 0.5 mM, 1 mM, 2 mM, 3 mM, 4 mM, 5 mM, 6 mM, 7 mM, 8 mM, 9 mM, 10 mM, 11 mM, 12 mM, 13 mM, 14 mM, 15 mM, 16 mM, 17 mM, 18 mM, 19 mM, or 20 mM MDJ. In some embodiments, the composition comprises about 1 mM MDJ. In some embodiments, the composition comprises about 10 mM MDJ.

In some embodiments, the composition comprises about 50 mg/L to about 5 g/L algae. In some embodiments, the composition comprises about 250 mg/L to about 1 g/L algae. In some embodiments, the composition comprises about 100, 150, 200, 250, 300, 350, 400, 450, 500, 550, 600, 650, 700, 750, 800, 850, 900, 950, or 1000 mg/L seaweed. In some embodiments, the composition comprises about 450 mg/L algae. In some embodiments, the algae is kelp. In some embodiments, the seaweed is Ascophyllum nodosum.

In some embodiments, the composition comprises about 10 μM to about 50 mM surfactant. In some embodiments, the composition comprises about 0.1 to about 10 mM surfactant. In some embodiments, the composition comprises about 0.1, 0.2, 0.3, 0.4, 0.5, 0.6, 0.7, 0.8, 0.9, 1, 2, 3, 4, 5, 6, 7, 8, 9, or 10 mM surfactant. In some embodiments, the composition comprises about 0.4 mM surfactant. In some embodiments, the composition comprises about 4 mM surfactant. In some embodiments, the surfactant is polysorbate-20.

In some embodiments, the composition comprises potassium. In some embodiments, the composition comprises about 0.2-5 μM potassium. In some embodiments, the composition comprises about 1-3 μM potassium. In some embodiments, the composition comprises about 1.0, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, or 3.0 μM potassium. In some embodiments, the composition comprises about 1.9 μM potassium. In some embodiments, the composition comprises about 5-18% potassium by weight. In some embodiments, the composition comprises about 5, 6, 7, 8, 9, 10, 11, 12, 13, 14, 15, 16, 17, or 18% potassium by weight. In some embodiments, the composition comprises about 9% potassium by weight.

In some embodiments, the composition comprises phosphorous. In some embodiments, the composition comprises about 0.1-4 μM phosphorous. In some embodiments, the composition comprises about 0.5-2 μM phosphorous. In some embodiments, the composition comprises about 0.5, 0.6, 0.7, 0.8, 0.9, 1.0, 1.1, 1.2, 1.3, 1.4, 1.5, 1.6, 1.7, 1.8, 1.9, or 2 μM phosphorous. In some embodiments, the composition comprises about 1 μM phosphorous. In some embodiments, the composition comprises about 3-15% phosphorous by weight. In some embodiments, the composition comprises about 3, 4, 5, 6, 7, 8, 9, 10, 11, 12, 13, 14, or 15% phosphorous by weight. In some embodiments, the composition comprises about 7% phosphorous by weight.

In some embodiments, the composition comprises amino acids in addition to those comprised by the algae. In some embodiments, the composition comprises about 0.001% to about 0.1% amino acids by weight in addition to those comprised by the algae. In some embodiments, the composition comprises about 0.005% to about 0.05% amino acids by weight in addition to those comprised by the algae. In some embodiments, the composition comprises about 0.005, 0.006, 0.007, 0.008, 0.009, 0.01, 0.15, 0.02, 0.025, 0.03, 0.035, 0.04, 0.045, or 0.05% amino acids by weight in addition to those comprised by the algae. In some embodiments, the composition comprises about 0.15% amino acids by weight in addition to those comprised by the algae.

In some embodiments, the composition comprises nitrogen. In some embodiments, the composition comprises about 0.5 mM to about 100 mM nitrogen. In some embodiments, the composition comprises about 2 mM to about 20 mM nitrogen. In some embodiments, the composition comprises about 1, 2, 3, 4, 5, 6, 7, 8, 9, 10, 11, 12, 13, 14, 15, 16, 17, 18, 19, or 20 mM nitrogen. In some embodiments, the composition comprises about 4.5 mM nitrogen. In some embodiments, the composition comprises about 8.5 mM nitrogen. In some embodiments, the composition comprises less than 1% nitrogen by weight. In some embodiments, the composition comprises less than 0.1% nitrogen by weight. In some embodiments, the composition comprises less than 0.01% nitrogen by weight.

In some embodiments, the composition comprises fulvic acid. In some embodiments, the amount of fulvic acid in the composition is quantified based on the hydrophobic fulvic acid. In some embodiments, the composition comprises about 0.0005% to about 0.05% hydrophobic fulvic acid by weight. In some embodiments, the composition comprises about 0.001% to about 0.01% hydrophobic fulvic acid by weight. In some embodiments, the composition comprises about 0.001, 0.002, 0.003, 0.004, 0.005, 0.006, 0.007, 0.008, 0.009, or 0.01% hydrophobic fulvic acid by weight. In some embodiments, the composition comprises about 0.006% hydrophobic fulvic acid by weight.

In some embodiments, the composition comprises about 0.5-20 mM jasmonate, e.g., MDJ; about 250 mg/L to about 1 g/L algae, e.g., kelp, and about 0.1 to about 10 mM surfactant, e.g., polysorbate-20.

In some embodiments, the composition comprises about 0.5-20 mM jasmonate, e.g., MDJ; about 250 mg/L to about 1 g/L algae, e.g., kelp; about 0.1 to about 10 mM surfactant, e.g., polysorbate-20; about 1-3 μM potassium; about 0.5-2 μM phosphorous; about 0.05% to about 0.5% amino acids by weight in addition to those comprised by the kelp; and about 0.001% to about 0.01% hydrophobic fulvic acid by weight.

In some embodiments, the composition comprises about 0.5-20 mM jasmonate, e.g., MDJ; about 250 mg/L to about 1 g/L algae, e.g., kelp; about 0.1 to about 10 mM surfactant, e.g., polysorbate-20; about 1-3 μM potassium; about 0.5-2 μM phosphorous; about 0.005% to about 0.05% amino acids by weight in addition to those comprised by the algae; about 0.001% to about 0.01% hydrophobic fulvic acid by weight; and about 2 mM to about 20 mM nitrogen.

### Methods of Altering the Production of a Plant Metabolite

In some embodiments, the present disclosure teaches a method for altering the production of one or more secondary plant metabolites in a Cannabis spp. plant or plant part, comprising: applying an effective amount of an agricultural composition disclosed herein. In some embodiments, the metabolite is a cannabinoid. In some embodiments, the metabolite is a terpene.

### Secondary Metabolites

Secondary plant metabolites are compounds which are not required for the growth and reproduction of the organism, but provide some advantage to the organism (bacteria, fungi, and plants) and may be required for survival. For example, a secondary metabolite may attract a pollinator through color or scent, or provide defense from an invading bacterial, viral, or fungal species. They may confer protection from UV radiation, or an insect pest, or aid in wound healing. They are also responsible for the aromas and flavors of plants (which may deter predators). They can be classified based on their chemical structures. Example classes of secondary metabolites includes phenolics (tanins, coumarins, flavonoids, chromones and xanthones, stilbenes, lignans), alkaloids, saponins, terpenes, and cannabinoids.

### Secondary Metabolite Production in Cannabis

In some embodiments, the methods of the disclosure alter the production of a secondary metabolite in a Cannabis spp. plant or plant part.

Cannabis, more commonly known as marijuana, is a genus of flowering plants that includes at least three species, Cannabis sativa, Cannabis indica, and Cannabis ruderalis as determined by plant phenotypes and secondary metabolite profiles. In practice however, cannabis nomenclature is often used incorrectly or interchangeably. Cannabis literature can be found referring to all cannabis varieties as “sativas” or all cannabinoid producing plants as “indicas”. Indeed, the promiscuous crosses of indoor cannabis breeding programs have made it difficult to distinguish varieties, with most cannabis being sold in the United States having features of both sativa and indica species. The present disclosure provides for Cannabis sp. (species) or Cannabis spp. (species pluralis), which comprises Cannabis sativa, Cannabis indica, and Cannabis ruderalis, as well as hybrids and variants thereof.

The profile of secondary metabolites in Cannabis plants can be the primary determinant of the crop's value. In hemp crops, low-THC varieties are not only mandated by law but coveted by consumers and cultivators. Hemp crops are generally utilized for their secondary metabolites produce in planta in flower organs and other aerial tissues, which are extracted and refined using various techniques and solvents such as lipid and hydrocarbon extractions. In high-THC varieties, which are colloquially known as “marijuana”, less emphasis is placed on the variety of secondary metabolites and greater emphasis is placed on the concentration of the cannabinoids THCA (tetrahydrocannabinol acid) and its derivatives and/or the concentration of flavor and scent molecules like terpenes. In both instances, primary value of Cannabis crops has been determined by the concentration of the secondary metabolites known as cannabinoids and terpenes or terpenoids. Cannabis also produces flavonoids, steroids, alkaloids, phenols, and amides.

Cannabis plants produce a unique family of terpeno-phenolic compounds called cannabinoids. Cannabinoids, terpenoids, and other compounds are secreted by glandular trichomes that occur most abundantly on the floral calyxes and bracts of female plants. As a drug it usually comes in the form of dried flower buds (marijuana), resin (hashish), or various extracts collectively known as hashish oil. There are at least 483 identifiable chemical constituents known to exist in the cannabis plant (Rudolf Brenneisen, 2007, Chemistry and Analysis of Phytocannabinoids (cannabinoids produced by cannabis) and other Cannabis Constituents, In Marijuana and the Cannabinoids, ElSohly, ed.; incorporated herein by reference) and at least 85 different cannabinoids have been isolated from the plant (El-Alfy, Abir T, et al., 2010, “Antidepressant-like effect of delta-9-tetrahydrocannabinol and other cannabinoids isolated from Cannabis sativa L”, Pharmacology Biochemistry and Behavior 95 (4): 434-42; incorporated herein by reference). The two cannabinoids usually produced in greatest abundance are cannabidiol (CBD) and/or Δ⁹-tetrahydrocannabinol (THC). THC is psychoactive while CBD is not. See, ElSohly, ed. (Marijuana and the Cannabinoids, Humana Press Inc., 321 papers, 2007), which is incorporated herein by reference in its entirety, for a detailed description and literature review on the cannabinoids found in marijuana.

Some of the secondary metabolites produced include, but are not limited to, pentyl, propyl, C-4, C-1 and monomethylether constituents of cannabinoid families, including but not limited to acidic and neutral forms of the cannabigerol, cannabichromene, cannabidiol, delta-9-tetrahydrocannabinol, delta-8-tetrahydrocannabinol, cannabielsoin, cannabinol and cannabinodiol cannabinoid classes; and, cis and trans terpenoids, including but not limited to myrcene, limonene, linalool, ocimene, beta-pinene, alpha-pinene, beta-caryophyllene, alpha-caryophyllene, delta-3-carene, gamma-bisabolene, alpha-farnesene, beta-fenchol, guajol, alpha-guaiene, terpinolene, beta-eudesmol, alpha-bergamotene, epi-alpha-bisabolol and caryophyllene oxide.

In addition to cannabinoids, cannabis also produces over 120 different terpenes (Russo 2011, Taming THC: potential cannabis synergy and phytocannabinoid-terpenoid entourage effects, British Journal of Pharmacology, 163:1344-1364). Within the context and verbiage of this document the terms ‘terpenoid’ and ‘terpene’ are used interchangeably. Cannabinoids are odorless, so terpenoids are responsible for the unique odor of cannabis, and each variety has a slightly different profile that can potentially be used as a tool for identification of different varieties or geographical origins of samples (Hillig 2004. “A chemotaxonomic analysis of terpenoid variation in Cannabis” Biochem System and Ecology 875-891). It also provides a unique and complex organoleptic profile for each variety that is appreciated by both novice users and connoisseurs. In addition to many circulatory and muscular effects, some terpenes interact with neurological receptors. A few terpenes produced by cannabis plants also bind weakly to Cannabinoid receptors. Some terpenes can alter the permeability of cell membranes and allow in either more or less THC, while other terpenes can affect serotonin and dopamine chemistry as neurotransmitters. Terpenoids are lipophilic, and can interact with lipid membranes, ion channels, a variety of different receptors (including both G-protein coupled odorant and neurotransmitter receptors), and enzymes. Some are capable of absorption through human skin and passing the blood brain barrier.

Generally speaking, terpenes are considered to be pharmacologically relevant when present in concentrations of at least 0.05% in plant material (Hazekamp and Fischedick 2010. “Metabolic fingerprinting of Cannabis sativa L., cannabinoids and terpenoids for chemotaxonomic and drug standardization purposes” Phytochemistry 2058-73; Russo 2011, Taming THC: potential cannabis synergy and phytocannabinoid-terpenoid entourage effects, British Journal of Pharmacology, 163:1344-1364). Thus, although there are an estimated 120 different terpenes, only a few are produced at high enough levels to be detectable, and fewer still which are able to reach pharmacologically relevant levels.

Some of the most common terpenes in cannabis include: terpinolene, alpha phelladrene, beta ocimene, carene, limonene, gamma terpinene, alpha pinene, alpha terpinene, beta pinene, fenchol, camphene, alpha terpineol, alpha humulene, beta caryophyllene, linalool, cary oxide, and myrcene. A survey of the terpene profiles of several cannabis varieties has found that these terpenes express at high enough levels so as to have their own pharmacological effects and also to act in synergy with cannabinoids. Both experts and consumers believe that there are biochemical and phenomenological differences between different varieties of cannabis, which are attributed to their unique relative cannabinoid and terpenoid ratios. This is known as the entourage effect and is generally considered to result in plants providing advantages over only using the natural products that are isolated from them (Russo 2011, Taming THC: potential cannabis synergy and phytocannabinoid-terpenoid entourage effects, British Journal of Pharmacology, 163:1344-1364).

These advantages include synergy with THC, the primary active ingredient, and also mitigation of side effects from THC (McPartland and Russo 2001 “Cannabis and Cannabis Extracts: Greater Than the Sum of Their Parts?” Hayworth Press). Terpenoids can be extracted from the plant material by steam distillation (giving you essential oil) or vaporization, however the yield varies greatly by plant tissue, type of extraction, age of material, and other variables (McPartland and Russo 2001 “Cannabis and Cannabis Extracts: Greater Than the Sum of Their Parts?” Hayworth Press). Typically the yield of terpenoids in cannabis is less than 1% by weight on analysis; however it is thought that they may comprise up to 10% of the trichome content. Monoterpenoids are especially volatile, thus decreasing their yield relative to sesquiterpenoids (Russo 2011, Taming THC: potential cannabis synergy and phytocannabinoid-terpenoid entourage effects, British Journal of Pharmacology, 163:1344-1364).

### Cannabinoids

In some embodiments, the methods of the disclosure alter the production of a cannabinoid in a Cannabis spp. plant or plant part. In some embodiments, the methods of the disclosure increase a cannabinoids in a Cannabis spp. plant or plant part.

Cannabinoids are a class of diverse chemical compounds that activate cannabinoid receptors. Cannabinoids produced by plants are called phytocannabinoids, a.k.a., natural cannabinoids, herbal cannabinoids, and classical cannabinoids. Cannabinoids are the most studied group of secondary metabolites in cannabis. Recent research however has now identified compounds in other plants, for example, clove, black pepper, echinacea, broccoli, ginseng, and carrots, that interact directly with cannabinoid receptors (Gertsch J, Pertwee R G, Di Marzo V. Phytocannabinoids beyond the Cannabis plant—do they exist?Br J Pharmacol. 2010; 160(3):523-529).

Biosynthetic pathway of cannabinoids has been studied. See Meijer et al. I, II, III, and IV (I: 2003, Genetics, 163:335-346; II: 2005, Euphytica, 145:189-198; III: 2009, Euphytica, 165:293-311; and IV: 2009, Euphytica, 168:95-112), each of which is herein incorporated by reference in its entirety for all purposes. According to the current model, phenolic precursors such as geranyl pyrophosphate (GPP) and polyketide, olivetolic acid (OA) are condensed by geranyl pyrophosphate olivetolate geranyltransferase (GOT) to form Cannabigerol acid (CBGA). Alternatively, GPP and divarine acid are condensed by GOT to form Cannabigerovarinic acid (CBGVA). CBGA or CBGAV is transformed to (1) CBC by CBC synthase or CBCV by CBCV synthase; (2) THC by THC synthase or THCV by THCV synthase; or (3) CBD by CBD synthase or CBDV by CBDV synthase. The genes coding for THC synthase and CBD synthase are found on the same B locus. Thus cannabis plants can be categorized into THC-CBD chemotypes based on the state of the B locus BT/BT (THC producing, chemotype I), BD/BD (CBD producing, chemotype III), and BT/BD (producing both THC and CBD, chemotype II). Additional information on the genetic regulation of cannabinoids can be found in Meijer et al. I, II, III, and IV (I: 2003, Genetics, 163:335-346; II: 2005, Euphytica, 145:189-198; III: 2009, Euphytica, 165:293-311; and IV: 2009, Euphytica, 168:95-112).

More details of cannabinoids synthesis and the properties and uses of these cannabinoids are described in Russo (2011, Taming THC: potential cannabis synergy and phytocannabinoid-terpenoid entourage effects, British Journal of Pharmacology, 163:1344-1364), Russo et al. (2006, A tale of two cannabinoids: the therapeutic rationale for combining tetrahydrocannabinol and cannabidiol, Medical Hypothesis, 2006, 66:234-246), Celia et al. (Impact of cannabidiol on the acute memory and psychotomimetic effects of smoked cannabis: naturalistic study, The British Journal of Psychiatry, 201, 197:285-290), de Mello Schier et al., (Cannabidiol, a Cannabis sativa constituent, as an anxiolytic drug, Rev. Bras. Psiquiatr, 2012, 34(S1):5104-5117), and Zhornitsky et al. (Cannabidiol in Humans—the Quest for Therapeutic Targets, Pharmaceuticals, 2012, 5:529-552), each of which is herein incorporated by reference in its entirety for all purposes.

At least 85 different cannabinoids have been isolated from the cannabis plant (El-Alfy et al., 2010, “Antidepressant-like effect of delta-9-tetrahydrocannabinol and other cannabinoids isolated from Cannabis sativa L”, Pharmacology Biochemistry and Behavior 95 (4): 434-42; Brenneisen, supra). Typical cannabinoids isolated from cannabis plants include, but are not limited to, include, but are not limited to, Δ⁹-Tetrahydrocannabinol (Δ⁹-THC), Δ⁸-Tetrahydrocannabinol (Δ⁸-THC), Cannabichromene (CBC), Cannabicyclol (CBL), Cannabidiol (CBD), Cannabielsoin (CBE), Cannabigerol (CBG), Cannabinidiol (CBND), Cannabinol (CBN), Cannabitriol (CBT), and their propyl homologs, including, but are not limited to cannabidivarin (CBDV), Δ⁹-Tetrahydrocannabivarin (THCV), cannabichromevarin (CBCV), and cannabigerovarin (CBGV). See Holley et al. (Constituents of Cannabis sativa L. XI Cannabidiol and cannabichromene in samples of known geographical origin, J. Pharm. Sci. 64:892-894, 1975) and De Zeeuw et al. (Cannabinoids with a propyl side chain in Cannabis, Occurrence and chromatographic behavior, Science 175:778-779), each of which is herein incorporated by reference in its entirety for all purposes. Non-THC cannabinoids can be collectively referred to as “CBs”, wherein CBs can be one of THCV, CBDV, CBGV, CBCV, CBD, CBC, CBE, CBG, CBN, CBND, and CBT cannabinoids.

Most cannabinoids exist in two forms, as acids and in neutral (decarboxylated) forms. The acid form is designated by an “A” at the end of its acronym (i.e. THCA). The phytocannabinoids are synthesized in the plant as acid forms, and while some decarboxylation does occur in the plant, it increases significantly post-harvest and the kinetics increase at high temperatures. (Sanchez and Verpoorte 2008). The biologically active forms for human consumption are the neutral forms. Decarboxylation is usually achieved by thorough drying of the plant material followed by heating it, often by either combustion, vaporization, or heating or baking in an oven. Unless otherwise noted, references to cannabinoids in a plant include both the acidic and decarboxylated versions (e.g., CBD and CBDA).

### Tetrahydrocannabinol (THC)

Known as delta-9-tetrahydrocannabinol (Δ9-THC), THC is the principal psychoactive constituent (or cannabinoid) of the cannabis plant. The initially synthesized and accumulated form in plant is THC acid (THCA).

THC has mild to moderate analgesic effects, and cannabis can be used to treat pain by altering transmitter release on dorsal root ganglion of the spinal cord and in the periaqueductal gray. Other effects include relaxation, alteration of visual, auditory, and olfactory senses, fatigue, and appetite stimulation. THC has marked antiemetic properties, and may also reduce aggression in certain subjects (Hoaken (2003). “Drugs of abuse and the elicitation of human aggressive behavior”. Addictive Behaviors 28: 1533-1554).

The pharmacological actions of THC result from its partial agonist activity at the cannabinoid receptor CB₁, located mainly in the central nervous system, and the CB₂ receptor, mainly expressed in cells of the immune system (Pertwee, 2006, “The pharmacology of cannabinoid receptors and their ligands: An overview”. International Journal of Obesity 30: S13-S18.) The psychoactive effects of THC are primarily mediated by its activation of CB1G-protein coupled receptors, which result in a decrease in the concentration of the second messenger molecule cAMP through inhibition of adenylate cyclase (Elphick et al., 2001, “The neurobiology and evolution of cannabinoid signaling”. Philosophical Transactions of the Royal Society B: Biological Sciences 356 (1407): 381-408.) It is also suggested that THC has an anticholinesterase action which may implicate it as a potential treatment for Alzheimer's and Myasthenia (Eubanks et al., 2006, “A Molecular Link Between the Active Component of Marijuana and Alzheimer's Disease Pathology”. Molecular Pharmaceutics 3 (6): 773-7.)

THC occurs mainly as tetrahydrocannabinolic acid (THCA, 2-COOH-THC). Geranyl pyrophosphate and olivetolic acid react, catalyzed by an enzyme to produce cannabigerolic acid, which is cyclized by the enzyme THC acid synthase to give THCA. Over time, or when heated, THCA is decarboxylated producing THC. The pathway for THCA biosynthesis is similar to that which produces the bitter acid humulone in hops. See Fellermeier et al., (1998, “Prenylation of olivetolate by a hemp transferase yields cannabigerolic acid, the precursor of tetrahydrocannabinol”. FEBS Letters 427 (2): 283-5); de Meijer et al. I, II, III, and IV (I: 2003, Genetics, 163:335-346; II: 2005, Euphytica, 145:189-198; III: 2009, Euphytica, 165:293-311; and IV: 2009, Euphytica, 168:95-112.)

Non-limiting examples of THC variants include:

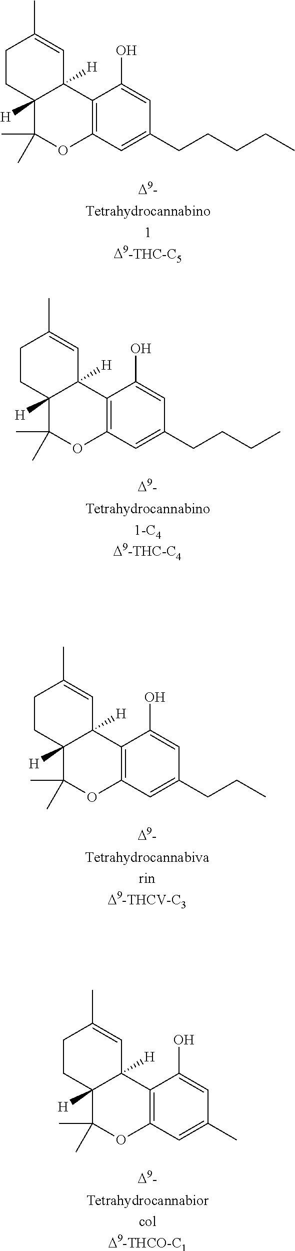

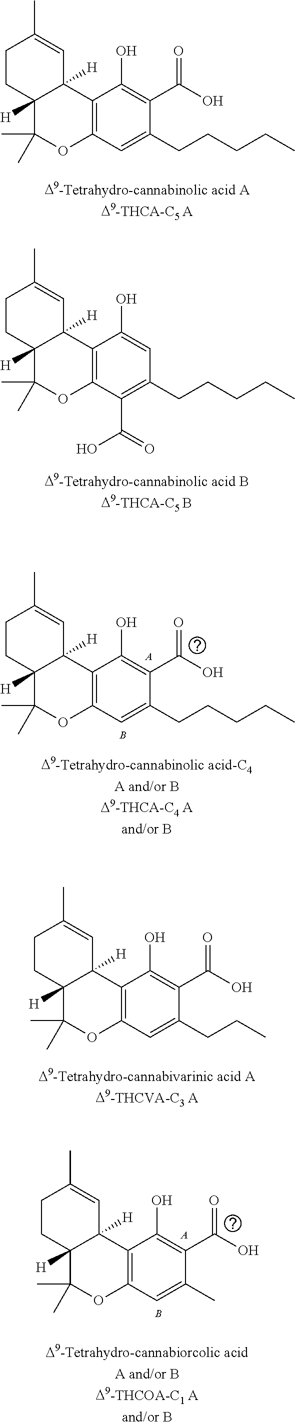

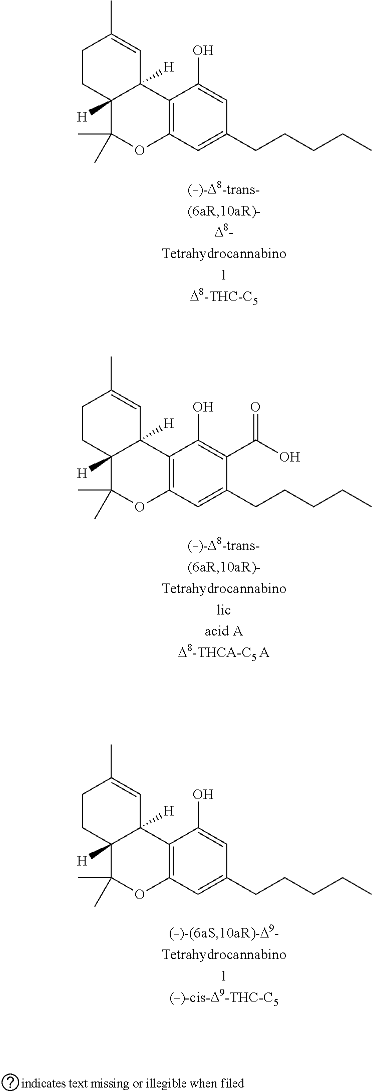

### Cannabidiol (CBD)

CBD is a cannabinoid found in cannabis. Cannabidiol has displayed sedative effects in animal tests (Pickens, 1981, “Sedative activity of cannabis in relation to its delta′-trans-tetrahydrocannabinol and cannabidiol content”. Br. J. Pharmacol. 72 (4): 649-56). Some research, however, indicates that CBD can increase alertness, and attenuate the memory-impairing effect of THC. (Nicholson et al., June 2004, “Effect of Delta-9-tetrahydrocannabinol and cannabidiol on nocturnal sleep and early-morning behavior in young adults” J Clin Psychopharmacol 24 (3): 305-13; Morgan et al., 2010, “Impact of cannabidiol on the acute memory and psychotomimetic effects of smoked cannabis: naturalistic study, The British Journal of Psychiatry, 197:258-290). It may decrease the rate of THC clearance from the body, perhaps by interfering with the metabolism of THC in the liver. Medically, it has been shown to relieve convulsion, inflammation, anxiety, and nausea, as well as inhibit cancer cell growth (Mechoulam, et al., 2007, “Cannabidiol—recent advances”. Chemistry & Biodiversity 4 (8): 1678-1692.) Recent studies have shown cannabidiol to be as effective as atypical antipsychotics in treating schizophrenia (Zuardi et al., 2006, “Cannabidiol, a Cannabis sativa constituent, as an antipsychotic drug” Braz. J. Med. Biol. Res. 39 (4): 421-429.). Studies have also shown that it may relieve symptoms of dystonia (Consroe, 1986, “Open label evaluation of cannabidiol in dystonic movement disorders”. The International journal of neuroscience 30 (4): 277-282). CBD reduces growth of aggressive human breast cancer cells in vitro and reduces their invasiveness (McAllister et al., 2007, “Cannabidiol as a novel inhibitor of Id-1 gene expression in aggressive breast cancer cells”. Mol. Cancer Ther. 6 (11): 2921-7.)

Cannabidiol has shown to decrease activity of the limbic system (de Souza Crippa et al., “Effects of Cannabidiol (CBD) on Regional Cerebral Blood Flow”. Neuropsychopharmacology 29 (2): 417-426.) and to decrease social isolation induced by THC (Malon et al., “Cannabidiol reverses the reduction in social interaction produced by low dose Δ9-tetrahydrocannabinol in rats”. Pharmacology Biochemistry and Behavior 93 (2): 91-96.) It's also shown that Cannabidiol reduces anxiety in social anxiety disorder (Bergamaschi et al., 2003, “Cannabidiol Reduces the Anxiety Induced by Simulated Public Speaking in Treatment-Naïve Social Phobia Patients”. Neuropsychopharmacology 36 (6): 1219-1226). Cannabidiol has also been shown as being effective in treating an often drug-induced set of neurological movement disorders known as dystonia (Snider et al., 1985, “Beneficial and Adverse Effects of Cannabidiol in a Parkinson Patient with Sinemet-Induced Dystonic Dyskinesia”. Neurology, (Suppl 1): 201.) Morgan et al. reported that strains of cannabis which contained higher concentrations of Cannabidiol did not produce short-term memory impairment vs. strains which contained similar concentrations of THC (2010, “Impact of cannabidiol on the acute memory and psychotomimetic effects of smoked cannabis: naturalistic study: naturalistic study [corrected.” ]. British Journal of Psychiatry 197 (4): 285-90.)

Cannabidiol acts as an indirect antagonist of cannabinoid agonists. CBD is an antagonist at the putative new cannabinoid receptor, GPR55. Cannabidiol has also been shown to act as a 5-HT1A receptor agonist, an action which is involved in its antidepressant, anxiolytic, and neuroprotective effects. Cannabidiol is also an allosteric modulator at the Mu and Delta opioid receptor sites.

Cannabis produces CBD-carboxylic acid through the same metabolic pathway as THC, until the last step, where CBDA synthase performs catalysis instead of THCA synthase. See Marks et al. (2009, “Identification of candidate genes affecting Δ9-tetrahydrocannabinol biosynthesis in Cannabis sativa”. Journal of Experimental Botany 60 (13): 3715-3726.) and Meijer et al. I, II, III, and IV.

Non-limiting examples of CBD variants include:

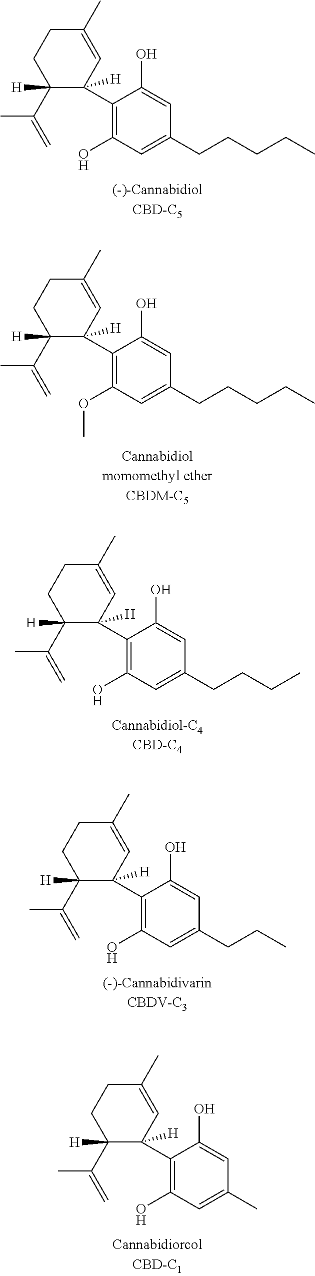

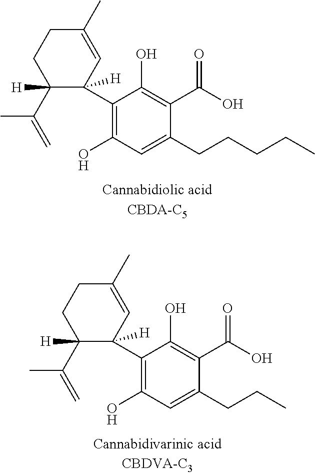

### Cannabigerol (CBG)

CBG is a non-psychoactive cannabinoid found in the Cannabis genus of plants. Cannabigerol is found in higher concentrations in hemp rather than in varieties of Cannabis cultivated for high THC content and their corresponding psychoactive properties. Cannabigerol has been found to act as a high affinity α2-adrenergic receptor agonist, moderate affinity 5-HT1A receptor antagonist, and low affinity CB₁ receptor antagonist. It also binds to the CB₂ receptor. Cannabigerol has been shown to relieve intraocular pressure, which may be of benefit in the treatment of glaucoma (Craig et al. 1984, “Intraocular pressure, ocular toxicity and neurotoxicity after administration of cannabinol or cannabigerol” Experimental eye research 39 (3):251-259). Cannabigerol has also been shown to reduce depression in animal models (U.S. Pat. No. 8,481,085).

Non-limiting examples of CBG variants include:

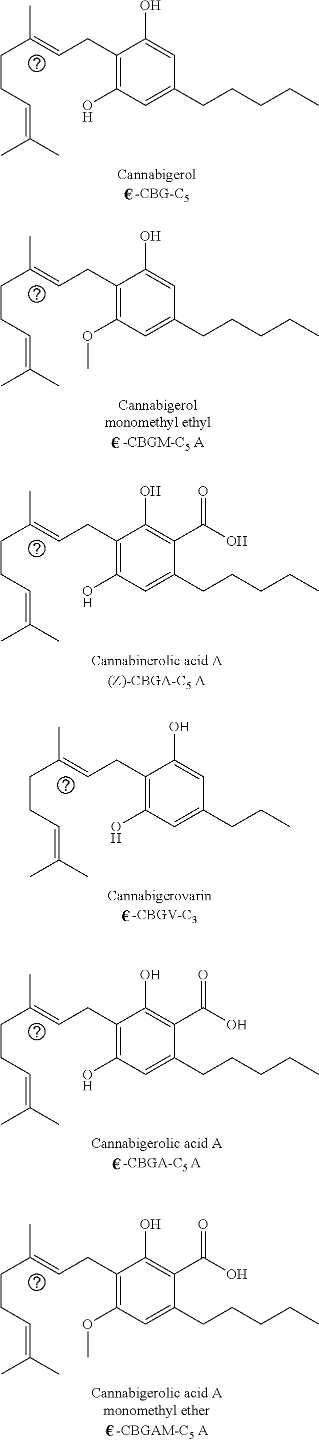

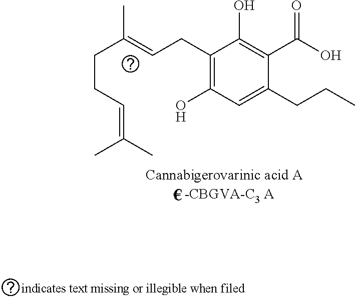 [SMILES: CCCc1cc(O)c(C/C=C(\C)CCC=C(C)C)c(O)c1C(=O)O]

### Cannabinol (CBN)

CBN is a psychoactive substance cannabinoid found in Cannabis sativa and Cannabis indica/afghanica. It is also a metabolite of tetrahydrocannabinol (THC). CBN acts as a weak agonist of the CB1 and CB2 receptors, with lower affinity in comparison to THC.

Non-limiting examples of CBN variants include:

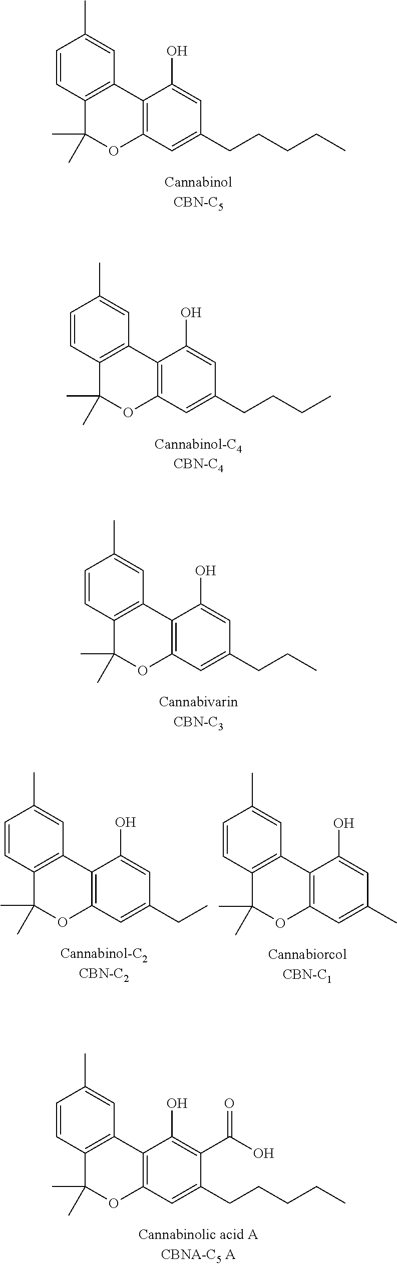

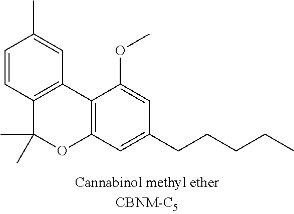 [SMILES: CCCCCc1cc(OC)c2c(c1)OC(C)(C)c1ccc(C)cc1-2]

### Cannabichromene (CBC)

CBC bears structural similarity to the other natural cannabinoids, including tetrahydrocannabinol, tetrahydrocannabivarin, cannabidiol, and cannabinol, among others. Evidence has suggested that it may play a role in the anti-inflammatory and anti-viral effects of cannabis, and may contribute to the overall analgesic effects of cannabis.

Non-limiting examples of CBC variants include:

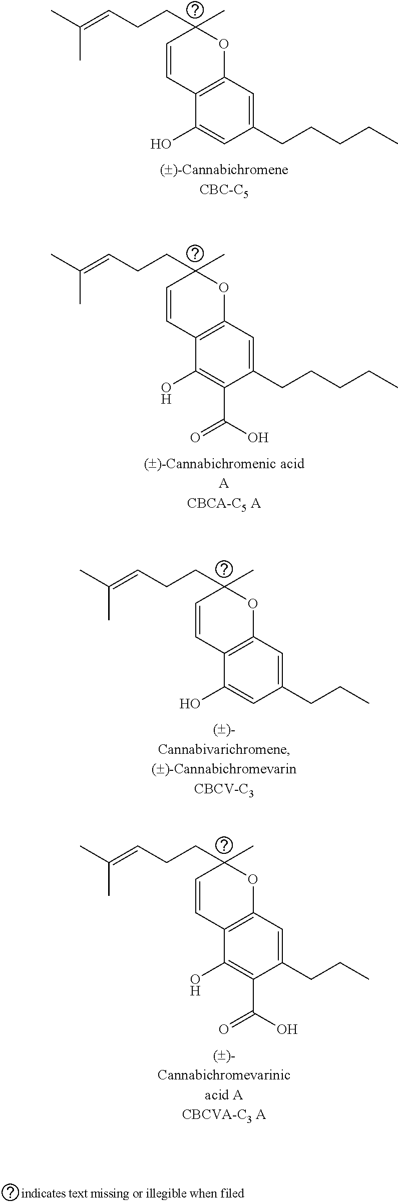

### Cannabivarin (CBV)

Cannabivarin, also known as cannabivarol or CBV, is a non-psychoactive cannabinoid found in minor amounts in the hemp plant Cannabis sativa. It is an analog of cannabinol (CBN) with the side chain shortened by two methylene bridges (—CH2-). CBV is an oxidation product of tetrahydrocannabivarin (THCV, THV).

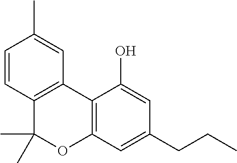 [SMILES: CCCc1cc(O)c2c(c1)OC(C)(C)c1ccc(C)cc1-2]

### Cannabidivarin (CBDV)

CBDV is a non-psychoactive cannabinoid found in Cannabis. It is a homolog of cannabidiol (CBD), with the side-chain shortened by two methylene bridges (CH2 units). Cannabidivarin has been found reduce the number and severity of seizures in animal models (U.S. Pat. No. 9,125,859). Plants with relatively high levels of CBDV have been reported in feral populations of C. indica (=C. sativa ssp. indica var. kafiristanica) from northwest India, and in hashish from Nepal.

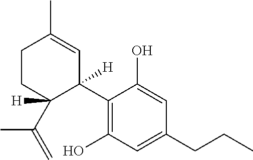 [SMILES: C=C(C)[C@@H]1CCC(C)=C[C@H]1c1c(O)cc(CCC)cc1O]

### Tetrahydrocannabivarin (THCV, THV)

THCV, or THV is a homologue of tetrahydrocannabinol (THC) having a propyl (3-carbon) side chain. This terpeno-phenolic compound is found naturally in Cannabis, sometimes in significant amounts. Plants with elevated levels of propyl cannabinoids (including THCV) have been found in populations of Cannabis sativa L. ssp. indica (=Cannabis indica Lam.) from China, India, Nepal, Thailand, Afghanistan, and Pakistan, as well as southern and western Africa. THCV has been shown to be a CB1 receptor antagonist, i.e. it blocks the effects of THC. Tetrahydrocannabinol has been shown to increase metabolism, help weight loss and lower cholesterol in animal models.

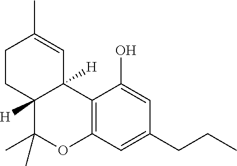 [SMILES: CCCc1cc(O)c2c(c1)OC(C)(C)[C@@H]1CCC(C)=C[C@@H]21]

### Cannabicyclol (CBL)

Cannabicyclol (CBL) is a non-psychotomimetic cannabinoid found in the Cannabis species. CBL is a degradative product like cannabinol. Light converts cannabichromene to CBL.

Non-limiting examples of CBL variants include:

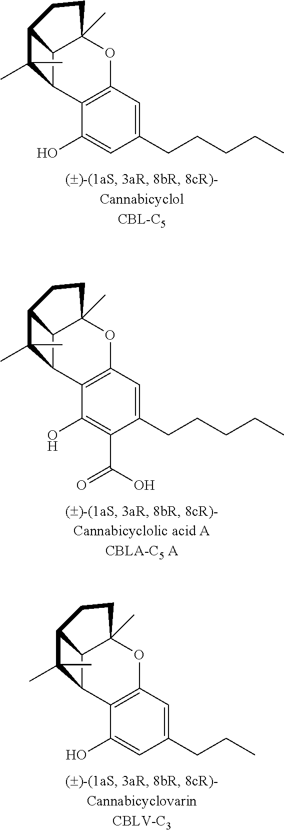

### Cannabitriol (CBT)

CBT occurs in small amounts and is not present in all cannabis varieties. It has a structure similar to THC, but it is a relatively newly discovered cannabinoid and thus has not been extensively studied.

Non-limiting examples of CBT variants include:

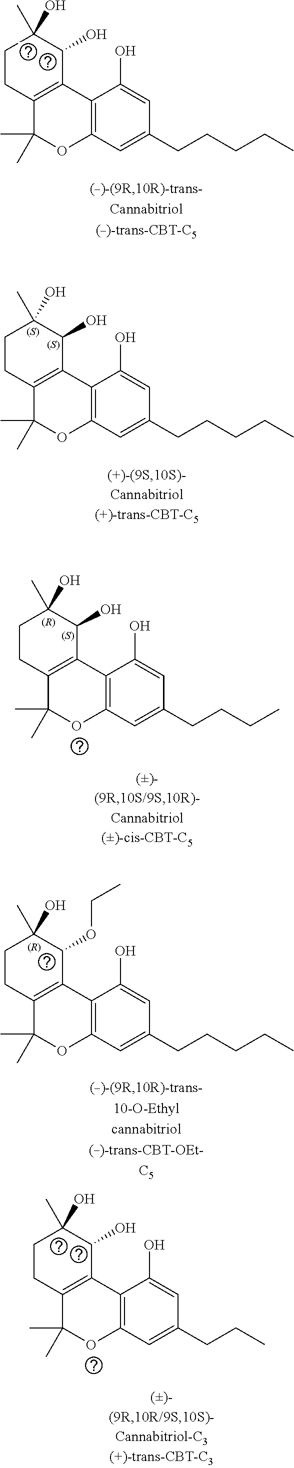

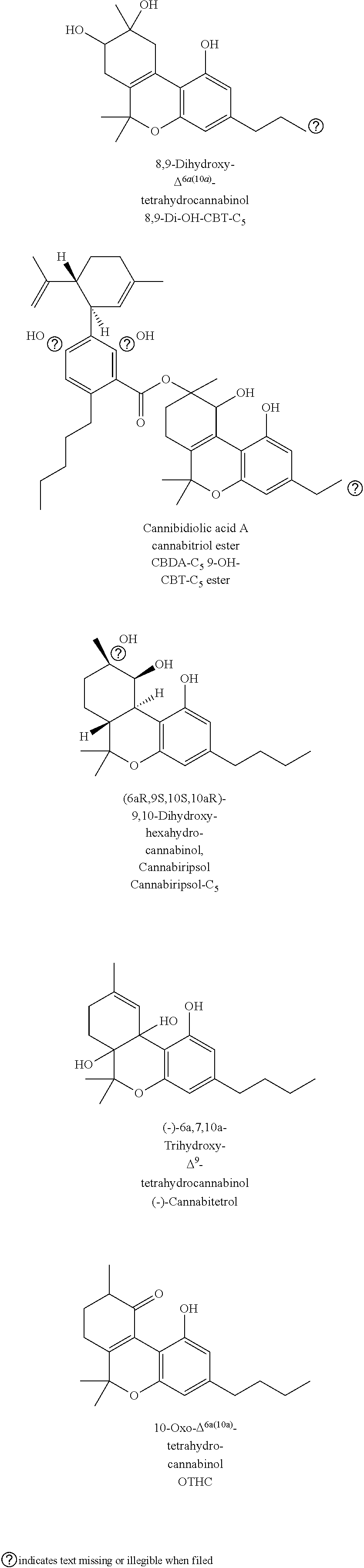

Medical uses for cannabinoids are well known in the art. See for example, Consroe, 1986, The International journal of neuroscience 30 (4): 277-282, Colasanti et al, Exp. Eye Res. 30:251-259, 1984, Gen. Pharmac. 15:479-484, 1984, Craig et al. 1984, Experimental eye research 39 (3):251-259, U.S. Pat. No. 6,630,507, Snider et al., 1985, “Beneficial and Adverse Effects of Cannabidiol in a Parkinson Patient with Sinemet-Induced Dystonic Dyskinesia”. Neurology, (Suppl 1): 201, U.S. Pat. No. 8,034,843, Mechoulam, et al., 2007, Chemistry & Biodiversity 4 (8): 1678-1692, Zuardi et al., 2006, Braz. J. Med. Biol. Res. 39 (4): 421-429, Bergamaschi et al., 2003, Neuropsychopharmacology 36 (6): 1219-1226, McAllister et al., 2007, Mol. Cancer Ther. 6 (11): 2921-7, Carlini et al., J. Clin. Pharmacol. 21:417S-427S, 1981, Karler et al., J. Clin. Pharmacol. 21:437S-448S, 1981, Consroe et al., J. Clin Pharmacol. 21:428S-436S, 1981, Patent Application Publication Nos. US20060135599, US20080139667, US20080262099, US20120004251, US20120165402, US20100035978, US20090306221, US20080119544, US20080031977, EP 1361864, EP 1542657, US20100286098, US20110082195, US20110038958, and US20110230549.

In some embodiments, application of the compositions disclosed herein alter the production of a cannabinoid in a plant or plant part. In some embodiments, the cannabinoid is Δ⁹-Tetrahydrocannabinol (Δ⁹-THC), Δ⁸-Tetrahydrocannabinol (Δ⁸-THC), Cannabichromene (CBC), Cannabicyclol (CBL), Cannabidiol (CBD), Cannabielsoin (CBE), Cannabigerol (CBG), Cannabinidiol (CBND), Cannabinol (CBN), Cannabitriol (CBT), cannabidivarin (CBDV), Δ⁹-Tetrahydrocannabivarin (THCV), cannabichromevarin (CBCV), or cannabigerovarin (CBGV).

In some embodiments, the disclosure teaches a method for producing a cannabinoid, the method comprising: a) applying an effective amount of methyl dihydrojasmonate to a Cannabis spp. plant, wherein said plant comprises an inflorescence; b) extracting a cannabinoid from said Cannabis sp. plant by either: i) contacting a part of the plant with a solvent, causing the cannabinoid to separate from the plant part; and/or ii) exposing a part of the plant to heat, causing the cannabinoid to separate from the plant part; and collecting said separated cannabinoid, thereby producing a cannabinoid. In some aspects, the method further comprises the step of admixing the cannabinoid with a carrier oil. In some aspects, the method further comprises the step of admixing the cannabinoid with a terpene.

All cannabinoids in their acid forms (those ending in “-A”) can be converted to their non-acidic forms through a process called decarboxylation. Decarboxylation is usually achieved by thorough drying of the plant material followed by heating it, often by either combustion, vaporization, or heating or baking in an oven. Cannabinoid compositions can similarly be decarboxylated by being exposed to heat.

In order to find the total amount of cannabinoids in a sample (e.g., total amount of active non-acidic cannabinoid), the total measured content of acid cannabinoid variants forms should be adjusted to account for the loss of the carboxyl group. In some embodiments, this adjustment can be made by multiplying the molar content of the acidic cannabinoid forms by the molecular weight of the corresponding decarboxylated cannabinoid. Other shorthand conversions are also available for quickly converting acidic cannabinoid content to active cannabinoid content.

For example, in some embodiments, THCA can be converted to active THC using the formula: THCA×0.877=THC. When using this approach, the maximum THC for the sample is: THCmax=(THCA×0.877)+THC. This method has been validated according to the principles of the International Conference on Harmonization. Similarly, CBDA can be converted to active CBD and the yield is determined using the yield formula: CBDA×0.877=CBD. Also, the maximum amount of CBD yielded, i.e. max CBD for the sample is: CBDmax=(CBDA×0.877)+CBD. Additionally, CBGA can be converted to active CBG by multiplying CBGA by 0.878 (CBGmax=(CBGA×0.878)+CBG). THCVA and CBDVA can be converted to THCV and CBDV, respectively by multiplying their acidic contents by 0.8668 (THCVmax=(THCVA×0.8668)+THCV; CBDVmax=(CBDVA×0.8668)+CBDV). CBGVA can be converted to CBGV by multiplying CBGVA by 0.8676 (CBGVmax=(CBGVA×0.8676)+CBGV).

### Terpenes

In some embodiments, the methods of the disclosure alter the production of a terpene in a Cannabis spp. plant or plant part.

Terpenes are a large and diverse class of organic compounds, produced by a variety of plants. They are often strong smelling and thus may have had a protective function. Terpenes are derived biosynthetically from units of isoprene, which has the molecular formula C₅H₈. The basic molecular formulae of terpenes are multiples of that, (C₅H₈)ₙ where n is the number of linked isoprene units. The isoprene units may be linked together “head to tail” to form linear chains or they may be arranged to form rings. Non-limiting examples of terpenes include Hemiterpenes, Monoterpenes, Sesquiterpenes, Diterpenes, Sesterterpenes, Triterpenes, Sesquarterpenes, Tetraterpenes, Polyterpenes, and Norisoprenoids.

Terpenoids, a.k.a. isoprenoids, are a large and diverse class of naturally occurring organic chemicals similar to terpenes, derived from five-carbon isoprene units assembled and modified in thousands of ways. Most are multicyclic structures that differ from one another not only in functional groups but also in their basic carbon skeletons. Plant terpenoids are used extensively for their aromatic qualities. They play a role in traditional herbal remedies and are under investigation for antibacterial, antineoplastic, and other pharmaceutical functions. The terpene Linalool for example, has been found to have anti-convulsant properties (Elisabetsky et al., Phytomedicine, May 6(2):107-13 1999). Well-known terpenoids include citral, menthol, camphor, salvinorin A in the plant Salvia divinorum, and the cannabinoids found in Cannabis. Non-limiting examples of terpenoids include, Hemiterpenoids, 1 isoprene unit (5 carbons); Monoterpenoids, 2 isoprene units (10 C); Sesquiterpenoids, 3 isoprene units (15 C); Diterpenoids, 4 isoprene units (20 C) (e.g. ginkgolides); Sesterterpenoids, 5 isoprene units (25 C); Triterpenoids, 6 isoprene units (30 C) (e.g. sterols); Tetraterpenoids, 8 isoprene units (40 C) (e.g. carotenoids); and Polyterpenoid with a larger number of isoprene units.

Terpenoids are mainly synthesized in two metabolic pathways: mevalonic acid pathway (a.k.a. HMG-CoA reductase pathway, which takes place in the cytosol) and MEP/DOXP pathway (a.k.a. The 2-C-methyl-D-erythritol 4-phosphate/1-deoxy-D-xylulose 5-phosphate pathway, non-mevalonate pathway, or mevalonic acid-independent pathway, which takes place in plastids). Geranyl pyrophosphate (GPP), which is used by cannabis plants to produce cannabinoids, is formed by condensation of dimethylallyl pyrophosphate (DMAPP) and isopentenyl pyrophosphate (IPP) via the catalysis of GPP synthase. Alternatively, DMAPP and IPP are ligated by FPP synthase to produce farnesyl pyrophosphate (FPP), which can be used to produce sesquiterpenoids. Geranyl pyrophosphate (GPP) can also be converted into monoterpenoids by limonene synthase.

In some embodiments, the production of terpenes and terpenoids derived from isoprene units, including acyclic, monocyclic, bicyclic, tricyclic, tetracyclic, pentacyclic, hexacyclic, heptacyclic, and octacyclic cyclisations of hemiterpenes, monoterpenes, sesquiterpenes, diterpenes, sesterterpenes, triterpenes, sesquarterpenes, tetraterpenes, and polyterpenes are manipulated independently of each other. In some embodiments, the production of terpenes and terpenoids derived from isoprene units, including acyclic, monocyclic, bicyclic, tricyclic, tetracyclic, pentacyclic, hexacyclic, heptacyclic, and octacyclic cyclisations of hemiterpenes, monoterpenes, sesquiterpenes, diterpenes, sesterterpenes, triterpenes, sesquarterpenes, tetraterpenes, and polyterpenes are manipulated relative to each other.

### Limonene

D-Limonene is a monoterpenoid that is widely distributed in nature and often associated with citrus. It has strong anxiolytic properties in both mice and humans, apparently increasing serotonin and dopamine in mouse brain. D-limonene has potent anti-depressant activity when inhaled. It is also under investigation for a variety of different cancer treatments, with some focus on its hepatic metabolite, perillic acid. There is evidence for activity in the treatment of dermatophytes and gastro-oesophageal reflux, as well as having general radical scavenging properties (Russo 2011, Taming THC: potential cannabis synergy and phytocannabinoid-terpenoid entourage effects, British Journal of Pharmacology, 163:1344-1364).

### Myrcene

β-Myrcene is a monoterpenoid also found in cannabis, and has a variety of pharmacological effects. It is often associated with a sweet fruit like taste. It reduces inflammation, aids sleep, and blocks hepatic carcinogenesis, as well as acting as an analgesic and muscle relaxant in mice. When β-myrcene is combined with Δ9-THC it could intensify the sedative effects of Δ9-THC, causing the well-known “couch-lock” effect that some cannabis users experience (Russo 2011, Taming THC: potential cannabis synergy and phytocannabinoid-terpenoid entourage effects, British Journal of Pharmacology, 163:1344-1364).

### Linalool

Linalool is a monoterpenoid with very well-known anxiolytic effects. It is often associated with lavender, and frequented used in aromatherapy for its sedative impact. It acts as a local anaesthetic and helps to prevent scarring from burns, is anti-nociceptive in mice, and shows antiglutamatergic and anticonvulsant activity. Its effects on glutamate and GABA neurotransmitter systems are credited with giving it its sedative, anxiolytic, and anticonvulsant activities (Russo 2011, Taming THC: potential cannabis synergy and phytocannabinoid-terpenoid entourage effects, British Journal of Pharmacology, 163:1344-1364). Exemplary plants that produce linalool are shown below in Table 2.

### α-Pinene

α-Pinene is a monoterpene common in nature, also with a plethora of effects on mammals and humans. It acts as an acetylcholinesterase inhibitor which aids memory and counteracts the short-term memory loss associated with Δ9-THC intoxication, is an effective antibiotic agent, and shows some activity against MRSA. In addition, α-pinene is a bronchodilator in humans and has anti-inflammatory properties via the prostaglandin E-1 pathway (Russo 2011, Taming THC: potential cannabis synergy and phytocannabinoid-terpenoid entourage effects, British Journal of Pharmacology, 163:1344-1364). Exemplary plants that produce α-pinene are shown below in Table 2.

### β-Caryophyllene

β-Caryophyllene is often the most predominant sesquiterpenoid in cannabis. It is less volatile than the monoterpenoids, thus it is found in higher concentrations in material that has been processed by heat to aid in decarboxylation. It is very interesting in that it is a selective full agonist at the CB₂ receptor, which makes it the only phytocannabinoid found outside the cannabis genus. In addition, it has anti-inflammatory and gastric cytoprotective properties, and may even have anti-malarial activity. Exemplary plants that produce β-caryophyllene are shown below in Table 2.

### Caryophyllene Oxide

Caryophyllene oxide is another sesquiterpenoid found in cannabis, which has antifungal and anti-platelet aggregation properties. As an aside, it is also the molecule that drug-sniffing dogs are trained to find (Russo 2011, Taming THC: potential cannabis synergy and phytocannabinoid-terpenoid entourage effects, British Journal of Pharmacology, 163:1344-1364). Exemplary plants that produce caryophyllene oxide are shown below in Table 2.

### Nerolidol

Nerolidol is a sesquiterpene that is often found in citrus peels that exhibits a range of interesting properties. It acts as a sedative, inhibits fungal growth, and has potent anti-malarial and antileishmanial activity. It also alleviated colon adenomas in rats (Russo 2011, Taming THC: potential cannabis synergy and phytocannabinoid-terpenoid entourage effects, British Journal of Pharmacology, 163:1344-1364). Phytol is a diterpene often found in cannabis extracts. It is a degradation product of chlorophyll and tocopherol. It increases GABA expression and therefore could be responsible the relaxing effects of green tea and wild lettuce. It also prevents vitamin-A induced teratogenesis by blocking the conversion of retinol to its dangerous metabolite, all-trans-retinoic acid (Russo 2011, Taming THC: potential cannabis synergy and phytocannabinoid-terpenoid entourage effects, British Journal of Pharmacology, 163:1344-1364). Exemplary plants that produce nerolidol are shown below in Table 2.

Additional terpenes are summarized in Table 2, with their individual organoleptic properties as well as their basic pharmacology and some types of plants that produce them.

TABLE 2
Non-limiting list of the medical effects of some common terpenes

| | Odor | | |
|---|---|---|---|
| Terpenoid | Description | Suggested Pharmacology | Found In |
| α-pinene | Herbal, piney | Anti-inflammatory, | Rosemary, basil, dill, |
| | | bronchodilator, stimulant | cedar, cannabis, |
| | | | eucalyptus, parsley, lime |
| | | | peel, lemon peel |
| camphene | Woody, piney | Reduces plasma cholesterol | Cannabis, conifer, |
| | | and triglycerides, Antioxidant | nutmeg, ginger, |
| | | and free radical scavenger | rosemary, dill, |
| | | | caraway, hyssop, |
| | | | cypress, citronella, |
| | | | valerian, fennel |
| β-pinene | Herbal, cooling, | Strong antimicrobial | Cumin, cannabis, hop |
| | piney | | |
| myrcene | Spicy, | Anti-inflammatory, | Bay leaves, hop, |
| | herbaceous | sedative, antibiotic, | thyme, lemon grass, |
| | | analgesic | verbena, cardamom, |
| | | | mango, cannabis |
| α-phellandrene | Terpenic, citrus | Antinociceptive | Eucalyptus, dill, black |
| | | | pepper, mint, parsley, |
| | | | cinnamon, lavender, pine, |
| | | | ginger grass, water |
| | | | fennel, cannabis |
| carene | Citrus, sweet | CNS depressant, anti- | Allspice, rosemary, |
| | | inflammatory | basil, cedar, pine, |
| | | | turpentine, cannabis |
| α-terpinene | Woody, citrus, | Antioxidant | Cumin, tea tree, |
| | medicinal | | oregano, coriander, |
| | | | cannabis |
| limonene | Citrus, fresh | Anxiolytic, antidepressant, | Red and silver maple, |
| | | immunostimulant | oranges, lemons, |
| | | | limes, cannabis |
| β-ocimene | Floral, green | Possible anti-bacterial | Grape hyacinth, |
| | | | buttercup, Euphorbia |
| | | | flavicoma, Iris, cannabis, |
| | | | cucumber, lima beans |
| γ-terpinene | Terpenic, woody | Antioxidant | Cannabis, cumin, tea |
| | | | tree, Origanum |
| | | | syriacum, coriander |
| terpinolene | Herbal, woody | Comforting, calming, anti- | Sage, lilac, rosemary, |
| | | oxidant, antifungal | apples, tea trees, |
| | | | cannabis |
| linalool | Floral, citrus | Sedative, anxiolytic, | Mint, sage, basil, |
| | | immunostimulant | rosemary, oregano, |
| | | | Thyme, lavender, celery, |
| | | | carrot, parsley, anise, |
| | | | caraway, fennel, cumin, |
| | | | Dill, parsnip, bay leaves |
| | | | Cinnamon, cilantro, |
| | | | grapes, coriander, black |
| | | | tea, green tea, lemons |
| | | | Nutmeg, mandarin, |
| | | | orange, ginger, |
| | | | frankincense, |
| | | | Lavender, rooibos tea |
| | | | Bergamont, cannabis |
| fenchol | Camphor, piney | Possible stimulant | Basil, eucalyptus, celery, |
| | | | nutmeg, aster flowers, |
| | | | citrus fruits, cannabis |
| α-terpineol | Floral, piney | Sedative, AChE inhibitor, | Lilac trees, pine trees, |
| | | antioxidant | lime blossoms, clary |
| | | | sage, coriander, |
| | | | lemon, star anise, |
| | | | mandarin orange, |
| | | | rosemary, lavender, |
| | | | juniper, eucalyptus, |
| | | | cannabis |
| β-caryophyllene | Spicy, woody | Selective agonist of CB2 | Black pepper, cloves, |
| | | receptor, anti--inflammatory, | hop, rosemary, copaiba, |
| | | antimalarial | cannabis |
| α-humulene | Woody | Anti-inflammatory | Hop, pine trees, oranges, |
| | | | tobacco, sunflower, sage, |
| | | | ginseng, mint, ginger, |
| | | | cannabis |
| caryophyllene | Woody, sweet | Antifungal, stimulant | Cannabis, caraway, |
| oxide | | | cloves, hop, basil, |
| | | | oregano, black pepper, |
| | | | lavender, rosemary, |
| | | | cinnamon |
| Nerolidol | Woody | Antioxidant, antifungal, | Ginger, jasmine, |
| | | antimicrobial | lavender, tea tree, lemon |
| | | | grass |
| Geraniol | Rose-like, floral, | Insect repellent, antibacterial | Geranium, rose, |
| | citrus | | palmarosa |

In some embodiments, application of the compositions disclosed herein alter the production of a terpene in a plant or plant part. In some embodiments, the terpene is α-pinene, camphene, β-pinene, myrcene, α-phellandrene, carene, α-terpinene, limone, β-ocimene, γ-terpinene, terpinolene, linalool, fenchol, α-terpineol, β-caryophyllene, α-humulene, caryophyllene oxide, nerolidol, or geraniol.

### Abiotic and Biotic Stressors

The methods and compositions of the present disclosure may increase plant survivability under one or more biotic or abiotic stressors. Examples of stressors include abiotic stresses, such as heat stress, salt (salinity) stress, drought stress, cold stress, excess water stress, and low nutrient stress. Examples of biotic stressors include pest and pathogens such as nematode stress, insect herbivory stress, fungal pathogen stress, bacterial pathogen stress, and viral pathogen stress.

Additional plant traits may be improved, such as: root biomass, root length, height, shoot length, leaf number, water use efficiency, overall biomass, yield, fruit size, grain size, photosynthesis rate, proteome expression, and metabolite production.

### Methods of Application

In some embodiments, the methods and compositions disclosed herein can be applied to seed, seedling, clone stock, vegetative tissues, root tissues, leaves, flowering tissues, and mature plant parts. The composition may be applied in liquid or dry form, using a foliar spray, a root drench or a gas to subterranean plant cells and/or aerial plant cells. The composition may be applied to the soil, to the plant, or to both the soil and the plant. The composition may be applied to plant parts using methods known in the art, such as foliar spray, atomization, fumigation, or chemigation. The composition may be applied to the soil using methods known in the art such as irrigation, chemigation, fertigation, or injection. The composition may be applied to a soil or a water or a carbon dioxide or a fertilizer source, including hydroponic and aeroponic and carbon dioxide injection systems, which is delivered to the plant in a liquid, dry, or gaseous form. In some embodiments, the plant may be grown indoors or outdoors, in a controlled or uncontrolled environment, in fields or in containers. The plant may be grown in soil-based media, soil-less media, or a media containing both soil-less and soil-based components. The plant may be grown in coco, rockwool, peat moss, or other acceptable medias well-known in the art. The plant may be grown with organic (Carbon-based), inorganic (synthetic), or a combination of both, fertilizers, amendments, adjuvants, pesticides, insecticides and supplements.

In some embodiments the compositions disclosed herein is/are applied to immature plants, seeds, or seedlings. In some embodiments, the compositions disclosed herein are applied to mature plants and/or plants in the reproductive stages. In some embodiments, the compositions disclosed herein are applied before harvest. In some embodiments, the compositions disclosed herein are applied between 24 and 72 hours before harvest. When the compositions disclosed herein are applied to growing plant parts or flowers, the same, or a different composition may be applied at a later stage of growth, or before harvest.

In some embodiments, the compositions disclosed herein are used independently or as a mixture to alter the production of valuable secondary metabolites by contacting some part of the plant or its environment at one or more distinct timepoints throughout the plant's lifecycle. The compositions disclosed herein may be applied once or more about: every day, every 2 days, every 3 days, every 4 days, every 5 days, every 6 days, every 7 days, every S days, every 9 days, every 10 days, every 11 days, every 12 days, every 13 days, every 14 days, every 15 days, every 16 days, every 17 days, every 18 days, every 19 days, every 20 days, every 21 days, every 22 days, every 23 days, every 24 days, every 25 days, every 26 days, every 27 days, every 28 days, every 29 days, every 30 days, every 31 days, every 32 days, every 33 days, every 34 days, every 35 days, every 36 days, every 37 days, every 38 days, every 39 days, every 40 days, every 41 days, every 42 days, every 43 days, every 44 days, every 45 days, every 46 days, every 47 days, every 48 days, every 49 days, every 50 days, every 51 days, every 52 days, every 53 days, every 54 days, every 55 days, every 56 days, every 57 days, every 58 days, every 59 days, every 60 days, every 61 days, every 62 days, every 63 days, every 64 days, every 65 days, every 66 days, every 67 days, every 68 days, every 69 days, every 70 days, every 71 days, every 72 days, every 73 days, every 74 days, every 75 days, every 76 days, every 77 days, every 78 days, every 79 days, every 80 days, every 81 days, every 82 days, every 83 days, every 84 days, every 85 days, every 86 days, every 87 days, every 88 days, every 89 days, every 90 days, every 91 days, every 92 days, every 93 days, every 94 days, every 95 days, every 96 days, every 97 days, every 98 days, every 99 days, every 100 days, every 101 days, every 102 days, every 103 days, every 104 days, every 105 days, every 106 days, every 107 days, every 108 days, every 109 days, every 110 days, or any combination of those days.

In some embodiments, the compositions disclosed herein may be applied only once during the entire plant lifecycle, or may be applied only once during the flowering cycle, or may be applied only once during the vegetative cycle, or may only be applied once prior to germination, or may be applied once prior to harvest. In some embodiments, the compositions disclosed herein is applied only on the first day of the flowering cycle.

The disclosed compositions and methods may be used to increase crop value by contacting young plants, seeds, clones or scions, vegetative plants, or other non-reproductive plant parts, or reproductive plant parts, to induce some desired response. The value of the crop may be determined by quantifying the concentration of secondary metabolites in plant parts with mass spectrometry, or by weight or volume measurements, or yield (concentration, weight, density, or relative abundance) of structures or organs, or by other physical or chemical means.

In some embodiments, the compositions and methods can be used to increase the production of valuable metabolites by weight, or to decrease the production of undesirable metabolites by weight, as determined by chemical analysis of plant or plant parts.

In some embodiments, the methods and composition disclosed herein alter the synthesis of a secondary metabolite. In some embodiments, the secondary metabolite is a terpene and/or a cannabinoid.

### Exemplary Methods

In some embodiments, the disclosed methods and compositions are used to alter the production of a secondary metabolite in a Cannabis spp. plant or plant part. Also disclosed herein are methods for improving resistance to biotic or abiotic stress in a Cannabis spp. plant or plant part. In some embodiments, the methods comprise applying an effective amount of an agricultural composition comprising a jasmonate, an algae, and a surfactant.

In some embodiments, the jasmonate is selected from the group consisting of methyl jasmonate, jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and analogues, isomers, derivatives or conjugates thereof. In some embodiments, the algae is a brown seaweed. In some embodiments, the seaweed is a kelp. In some embodiments, the algae is Ascophyllum nodosum. In some embodiments, the surfactant is a non-ionic surfactant. In some embodiments, the surfactant is polysorbate-20.

In some embodiments, the composition is applied prior to flower onset. As used herein, for Cannabis spp. flower onset is defined as the appearance of a flower primordia, or the continued formation of flowering structures, like pistils and calyx, on above ground plant parts, or the initiation of a photoperiod with about 12 hours of uninterrupted darkness. In some embodiments, the composition is applied after flower onset. In some embodiments, the composition is applied on the 30th day of the flowering cycle. In some embodiments, the composition is applied only once during the flowering cycle 72 hours prior to harvest. In some embodiments, the composition is applied only once during the flowering cycle 24 hours prior to harvest. In some embodiments, the composition is applied more than once during the plant lifecycle. In some embodiments, the composition is applied about every 10 to 14 days. In some embodiments, the composition is applied once a week, twice a week, or once every two weeks. In some embodiments, the composition is applied once or twice weekly starting from the onset of flowering until harvest.

In some embodiments, the composition is at a ready-to-apply dilution and is applied at a rate of about 0.5-2 liters per Cannabis plant. In some embodiments, the composition is at a high concentration and is diluted to a ready-to-apply dilution and is applied at a rate of about 0.5-2 liters per Cannabis plant. In some embodiments, a concentrated composition as disclosed herein, e.g., at 378-fold concentration, is applied at a rate of between 0.5 mL/gal and 40 mL/gal.

In some embodiments, the effective amount of jasmonate, e.g., MDJ, applied per plant per application is about 1 mol to about 1 mmol. In some embodiments, the effective amount of jasmonate, e.g., MDJ, applied per plant per application is about 10 mol. In some embodiments, the effective amount of jasmonate, e.g., MDJ, applied per plant per application is about 100 mol.

In some embodiments, the composition is applied as a root drench. In some embodiments, the composition is applied along with irrigation. In some embodiments, the composition is applied separately from regular irrigation. In some embodiments, the composition is applied as a foliar spray.

In some embodiments, the composition is applied two or more times, thereby carrying out a plurality of applications. In some embodiments, the composition is applied two or more times, and each application is separated by between 1-30 days. In some embodiments, the composition is applied at least two times separated by 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 days. In some embodiments, the composition is applied at least two times separated by 5-20 days. In some embodiments, the composition is applied about 24-72 hours prior to harvest.

In some embodiments, the composition is applied to a high-CBD variety Cannabis spp. plant or plant part. In some embodiments, the composition is applied to a high-THC variety Cannabis spp. plant or plant part. In some embodiments, the Cannabis spp. plant or plant part is a hemp variety.

In some embodiments, the secondary metabolite is a cannabinoid. In some embodiments, the cannabinoid is Δ⁹-Tetrahydrocannabinol (Δ⁹-THC), Δ⁹-Tetrahydrocannabinolic Acid (Δ⁹-THCA), Δ⁸-Tetrahydrocannabinol (Δ⁸-THC), Cannabichromene (CBC), Cannabicyclol (CBL), Cannabidiol (CBD), Cannabidiolic acid (CBDA), Cannabielsoin (CBE), Cannabigerol (CBG), Cannabigerolic Acid (CBG), Cannabinidiol (CBND), Cannabinol (CBN), Cannabitriol (CBT), cannabidivarin (CBDV), Δ⁹-Tetrahydrocannabivarin (THCV), cannabichromevarin (CBCV), or cannabigerovarin (CBGV). In some embodiments, the cannabinoid is Cannabichromene (CBC), Cannabidiol (CBD), Cannabidiolic Acid (CBDA), cannabidivarin (CBDV), Cannabigerol (CBG), Cannabigerolic Acid (CBGA), Δ9-Tetrahydrocannabinol (Δ9-THC), Δ9-Tetrahydrocannabinolic Acid (Δ9-THCA).

In some embodiments, the cannabinoid is increased compared to an untreated Cannabis spp. plant or plant part. In some embodiments, d9THCA, CBDA, d9THC, CBD, CBG, CBGA, and/or CBDV is increased in a Cannabis spp. plant or plant part treated with a composition of the disclosure compared to an untreated Cannabis spp. plant or plant part.

In some embodiments, the cannabinoid is decreased compared to an untreated Cannabis spp. plant or plant part. In some embodiments, d9THCA, CBC, and/or CBD is decreased in a Cannabis spp. plant or plant part treated with a composition of the disclosure compared to an untreated Cannabis spp. plant or plant part.

In some embodiments, the one or more secondary metabolites is a terpene. In some embodiments, the terpene is α-pinene, camphene, β-pinene, myrcene, β-myrcene, α-phellandrene, carene, α-terpinene, limonene, β-ocimene, γ-terpinene, terpinolene, linalool, fenchol, α-terpineol, β-caryophyllene, α-humulene, caryophyllene oxide, nerolidol, guaiol, α-bisabolol, geraniol, α-cedrene, α-terpineol, endo-fenchyl, limonene, or trans-caryophyllene. In some embodiments, the terpene is α-bisabolol, α-cedrene, α-humulene, α-pinene, α-terpineol, β-pinene, endo-fenchyl, limonene, or trans-caryophyllene

In some embodiments, the terpene is increased compared to an untreated Cannabis spp. plant or plant part. In some embodiments, the concentration of α-Humulene, α-Bisabolol, trans-Caryophyllene, α-Terpineol, Limonene, β-Pinene, β-Myrcene, and/or α-Pinene is increased in a Cannabis spp. plant or plant part treated with a composition of the disclosure compared to an untreated Cannabis spp. plant or plant part.

In some embodiments, the terpene is decreased compared to an untreated Cannabis spp. plant or plant part.

The effect on plants of the disclosed methods and compositions can be observed both genetically and chemically by any or all of the well-known analysis techniques including genomics, transcriptomics, proteomics, and metabolomics. The effect of different treatments on secondary metabolite production can influence the taste, smell, appearance, effect, quality, yield, stress tolerance, and/or productivity of the living plant and its harvestable plant parts.

### EXAMPLES

### Example 1: Formulation of Illustrative Agricultural Composition of the Disclosure

### Materials

Recipe for 1000 L:
498 mL polysorbate 20
226.32 g methyl dihydrojasmonate (“MDJ”) (technical grade, 97%+)
1 lb kelp (NPK Industries, RAW), species Ascophyllum nodosum
300 lbs mono-potassium phosphate (MKP)
50 kg KOH
6 L organic amino acid slurry (Impello® Lumina™, 2.5% amino acids)
10 L of Fulvic Acid (BioAg® Ful-Power™, 1% hydrophobic fulvic acid)

### Methods

MDJ Solution: One liter of an MDJ solution was formulated. For 1 L, 498 mL of polysorbate 20 were mixed with 226.32 g MDJ (technical grade, 97%+) and 275 mL H₂O, yielding 1 L of a 1 μM MDJ solution.

Illustrative Agricultural Composition: 50 kg KOH and 300 lbs MKP were added to about 200 gallons of water, with mixing after each addition. Then, 1 L of the MDJ solution, 6 L organic amino acids, 1 lb kelp, and 10 L fulvic acid were serially added with mixing after each addition. Finally H₂O was added to a final volume of 1000 L.

In the resulting agricultural composition, termed “Formula A” in the following example, the ratio of MDJ to kelp is 1:2.

### Example 2: Illustrative MDJ-Kelp Combination Compositions Modulate Cannabinoid and Terpene Production in Cannabis Plants

### Formulations

To test the effect of the combination of kelp and MDJ on secondary metabolite production, five different agricultural compositions were formulated.

Formula A: formula disclosed in Example 1.

Formula B: formula A without MDJ or polysorbate-20.

Formula C: formula A, but with 10-fold MDJ solution, yielding 10×MDJ and 10× polysorbate-20 compared to Formula A.

Formula D: formula A, without kelp; with the addition of 1 L of a 5.28% nitrogen-based fertilizer (Agroenzymas® The Equinox) per 1000 L of solution.

Formula E: formula A, without kelp, MDJ, or polysorbate-20; with the addition of 1 L of a 5.28% nitrogen-based fertilizer (Agroenzymas® The Equinox) per 1000 L of solution.

The contents and concentrations of each formula are shown in Table 3 below. The amino acid content is calculated only based on the contribution from the addition of Lumina™ amino acids. The nitrogen content is calculated based on the amount of nitrogen from both Lumina and Equinox. The potassium content is calculated based on the amount of KOH and MPK. The phosphorous content is calculated based on the amount of MPK.

TABLE 3
Approximate Composition of Formulas A-E.

| | Formula A | | Formula B | | Formula C | | Formula D | | Formula E | |
|---|---|---|---|---|---|---|---|---|---|---|
| MDJ | 1 | mM | 0 | mM | 10 | mM | 1 | mM | 0 | mM |
| Polysorbate-20 | 0.4 | mM | 0 | mM | 4 | mM | 0.4 | mM | 0 | mM |
| Kelp | 450 | mg/L | 450 | mg/L | 450 | mg/L | 0 | mg/L | 0 | mg/L |
| Potassium | 1.89M | | 1.89M | | 1.89M | | 1.89M | | 1.89M | |
| Phosphorous | 1M | | 1M | | 1M | | 1M | | 1M | |
| Amino Acids | 0.015% | | 0.015% | | 0.015% | | 0.015% | | 0.015% | |
| Nitrogen | 4.5 | mM | 4.5 | mM | 4.5 | mM | 8.5 | mM | 8.5 | mM |
| Hydrophobic | 0.006% | | 0.006% | | 0.006% | | 0.006% | | 0.006% | |
| Fulvic Acid | | | | | | | | | | |
| Ratio | 1:2 | | — | | 5:1 | | — | | — | |
| MDJ:Kelp | | | | | | | | | | |
| Ratio | 1:2.5 | | — | | 1:2.5 | | 1:2.5 | | — | |
| MDJ:polysorbate-20 | | | | | | | | | | |

### Hemp Growth and Treatments

Hemp clones of a high CBD strain were transplanted on Nov. 23, 2021 into coco substrate and fertigated with Impello® Biofuel™ (1% w/v application) and Lumina™ (10 mL/gallon). All plants were grown and maintained under equal conditions during the vegetative growth phase for six weeks. The plants were moved to a flowering room under HPS lights on Jan. 5, 2022 and set up in eight randomized blocks with eight plants per treatment group. The first treatment was applied at the end of the first week in flower.

All treatment groups received nutrient solution twice weekly (Biofuel and Lumina), as well as soil pH monitoring and standard integrated pest management regimens.

The treatments were applied to each plant at a concentration of 10 mL Formula/gallon. Treatments were applied up to twice per week as a root drench at a rate of one liter per plant per treatment. For the positive control group, a commercially available β-K fertilizer (Rock Resinator) was applied at the same rate as Formulas A-E, 10 mL/gallon, 1 liter/plant/treatment. The negative control received only nutrient solution. Table 4 shows the concentrations, percents, and molarities of each component in the dilute solutions applied to the plants as a root drench.

TABLE 4
Approximate Composition of Dilute Formulas A-E (10 mL formula/gallon H2O).

| | Formula A | | Formula B | | Formula C | | Formula D | | Formula E | |
|---|---|---|---|---|---|---|---|---|---|---|
| MDJ | 2.6 | μM | 0 | mM | 26 | μM | 2.6 | μM | 0 | mM |
| Polysorbate-20 | 1 | μM | 0 | mM | 10 | μM | 1 | μM | 0 | mM |
| Kelp | 1.2 | mg/L | 1.2 | mg/L | 1.2 | mg/L | 0 | mg/L | 0 | mg/L |
| Potassium | 5 | mM | 5 | mM | 5 | mM | 5 | mM | 5 | mM |
| Phosphorous | 2.6 | mM | 2.6 | mM | 2.6 | mM | 2.6 | mM | 2.6 | mM |
| Amino Acids | 0.0004% | | 0.0004% | | 0.0004% | | 0.0004% | | 0.0004% | |
| Nitrogen | 12 | μM | 12 | μM | 12 | μM | 22 | μM | 22 | μM |
| Hydrophobic | 1.6e−5% | | 1.6e−5% | | 1.6e−5% | | 1.6e−5% | | 1.6e−5% | |
| Fulvic Acid | | | | | | | | | | |
| Ratio | 1:2 | | — | | 5:1 | | — | | — | |
| MDJ:Kelp | | | | | | | | | | |
| Ratio | 1:2.5 | | — | | 1:2.5 | | 1:2.5 | | — | |
| MDJ:polysorbate-20 | | | | | | | | | | |

At the end of the growth cycle, flower samples from each plant were collected on Mar. 4, 2022. The apical cola for each plant was harvested, and specifically, the top 3″ of the main cola. Samples were weighed and frozen to be lyophilized for potency and terpene analysis. Analyses were performed by Altitude Consulting in Engelwood, CO. Statistical analysis of the quantitative cannabinoid and terpene data from plant samples taken at harvest was performed using R statistical software and/or ANOVA analysis and corrected post-hoc using Student's t-test.

The above and below ground fresh weight biomass was recorded and then hung at room temperature to air dry. Then dry weight biomass was recorded.

### Results

A number of terpenes were increased in plants that received formulas A and C, which comprised both MDJ and kelp, compared to plants that received formulas comprising only MDJ or only kelp. A summary of these results is shown in Table 5 below. Asterisks indicate level of significance compared to negative control: *, p<0.05; **, p<0.01; ***, p<0.001; * p<0.0001.

TABLE 5
Modulated terpene production in different treatment groups.

| | Increased terpene production | Decreased terpene production |
|---|---|---|
| Treatment | compared to negative control | compared to negative control |
| Formula A | α-Humulene*, α-Bisabolol***, trans- | |
| | Caryophyllene, α-Terpineol, | |
| | Limonene, β-Pinene, β-Myrcene*, α- | |
| | Pinene | |
| Formula B | α-Humulene*, α-Bisabolol*, trans- | α-Terpineol, endo-Fenchyl |
| (no MDJ or | Caryophyllene, Limonene, β-Pinene, | |
| polysorbate-20) | β-Myrcene, α-Pinene | |
| Formula C | α-Humulene*, α-Bisabolol**, α- | |
| (10-fold MDJ, | Terpineol, Limonene*, β-Pinene*, β- | |
| polysorbate-20) | Myrcene**, α-Pinene | |
| Formula D | α-Bisabolol* | trans-Caryophyllene*, α- |
| (no kelp, added | | Terpineol, endo-Fenchyl, |
| N) | | Limonene***, β-Pinene**, β- |
| | | Myrcene**, α-Pinene*** |
| Formula E | α-Humulene*, α-Bisabolol***, α- | trans-Caryophyllene, endo- |
| (no kelp, MDJ, | Terpineol | Fenchyl, Limonene**, β-Pinene, |
| polysorbate-20, | | β-Myrcene, α-Pinene |
| added N) | | |
| Rock Resinator | α-Humulene**, trans-Caryophyllene, | |
| (positive control) | α-Cedrene, α-Terpineol, Limonene, β- | |
| | Pinene, β-Myrcene*, α-Pinene | |

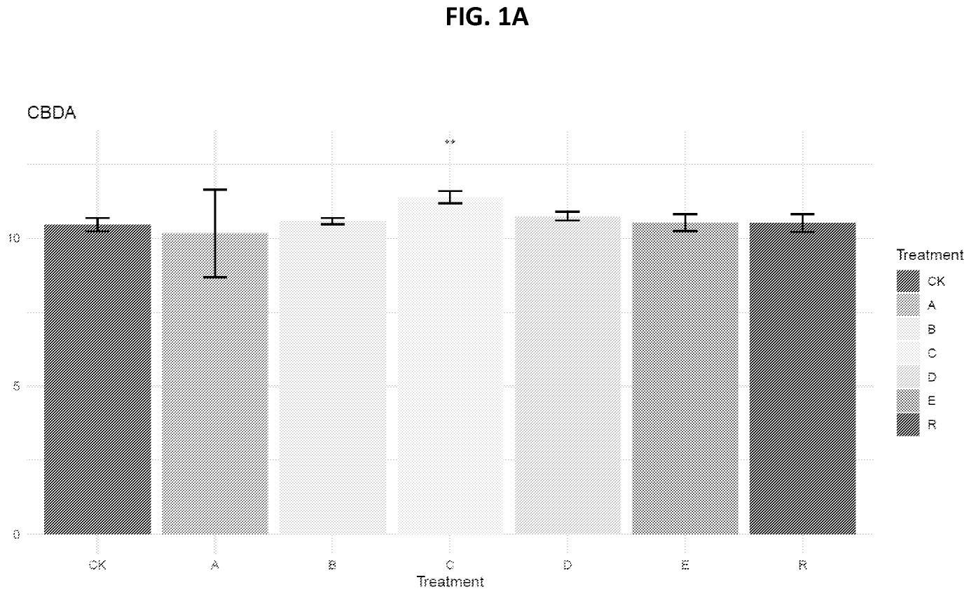

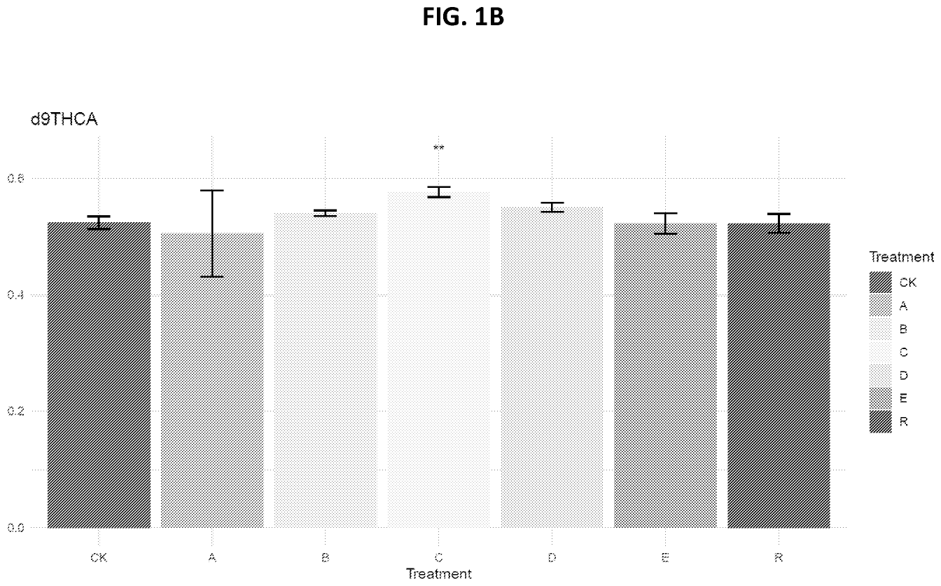

FIGS. 1A and 1B show the cannabinoid content in percent by weight in the plants of each treatment group compared to the negative and positive controls for CBDA (FIG. 1A) and d9THCA (FIG. 1B). Plants that received formula C, comprising both MDJ and kelp, exhibited significant increases in CBDA and d9THCA compared to formulas comprising only MDJ or only kelp. These results are also summarized in Table 6, below. Asterisks indicate level of significance compared to negative control (“CK”): *, p<0.05; **, p<0.01; ***, p<0.001; p<0.0001.

TABLE 6
Modulated cannabinoid production in different treatment groups.

| | Increased cannabinoid | Decreased cannabinoid |
|---|---|---|
| | production compared to | production compared to |
| Treatment | negative control | negative control |
| Formula A | d9THC, CBG, CBGA, CBDV | d9THCA, CBC, CBD |
| Formula B (no MDJ | d9THCA, CBDA, d9THC, CBG, | CBC, CBD |
| or polysorbate-20) | CBGA | |
| Formula C (10-fold | d9THCA**, CBDA**, d9THC, | CBC |
| MDJ, polysorbate-20) | CBD, CBG, CBGA | |
| Formula D (no kelp, | d9THCA, CBDA, CBG | CBC, CBD, CBGA |
| added N) | | |
| Formula E (no kelp, | CBDA, CBG | d9THC, CBC, CBD*, CBGA |
| MDJ, polysorbate-20, | | |
| added N) | | |
| Rock Resinator | CBDA, CBC, CBD, CBG, | d9THC |
| (positive control) | CBGA | |

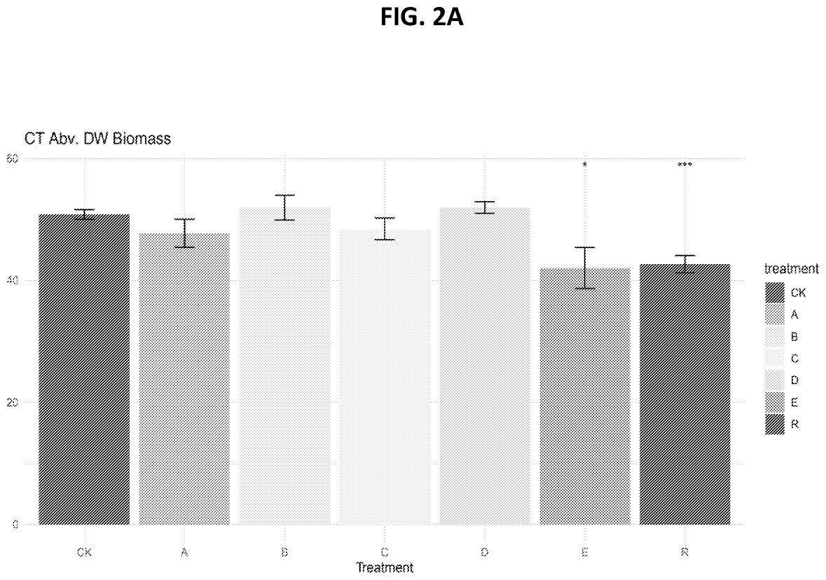

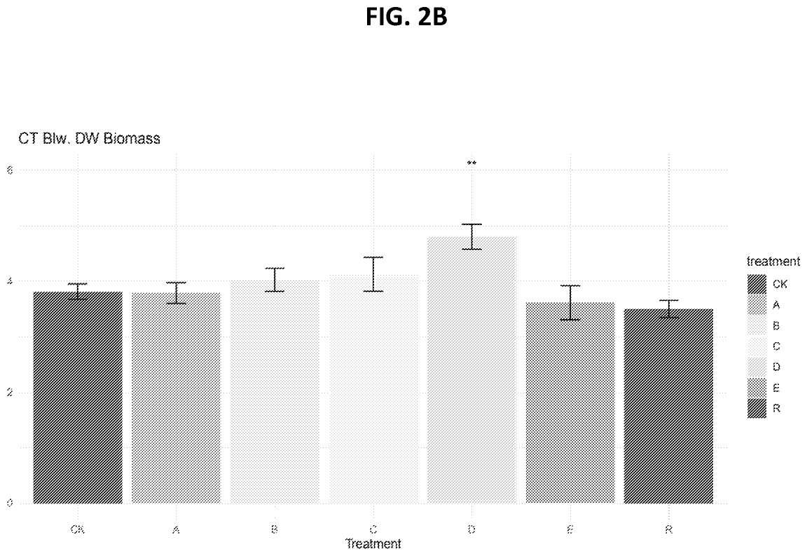

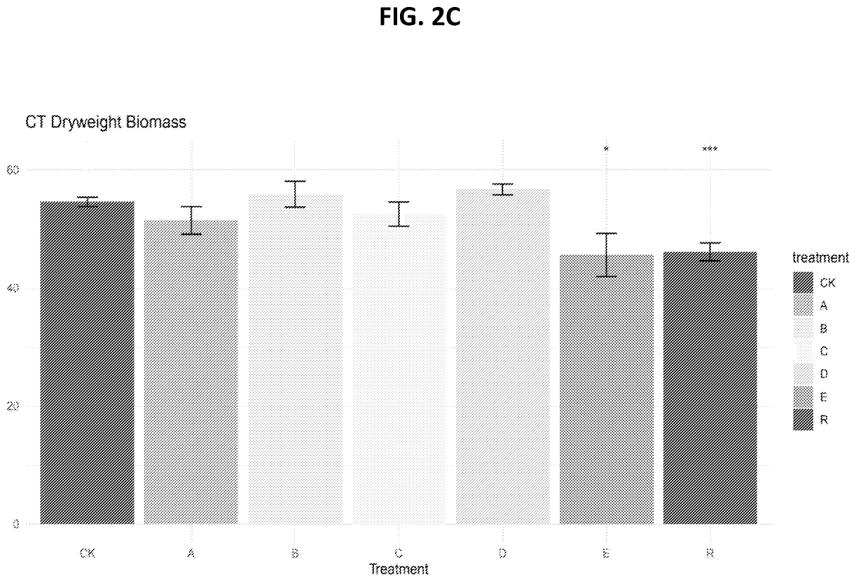

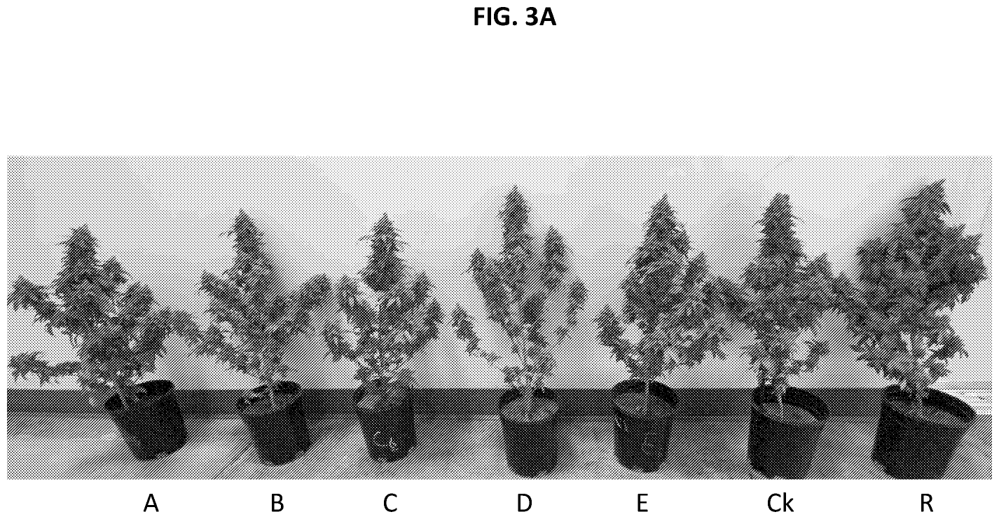

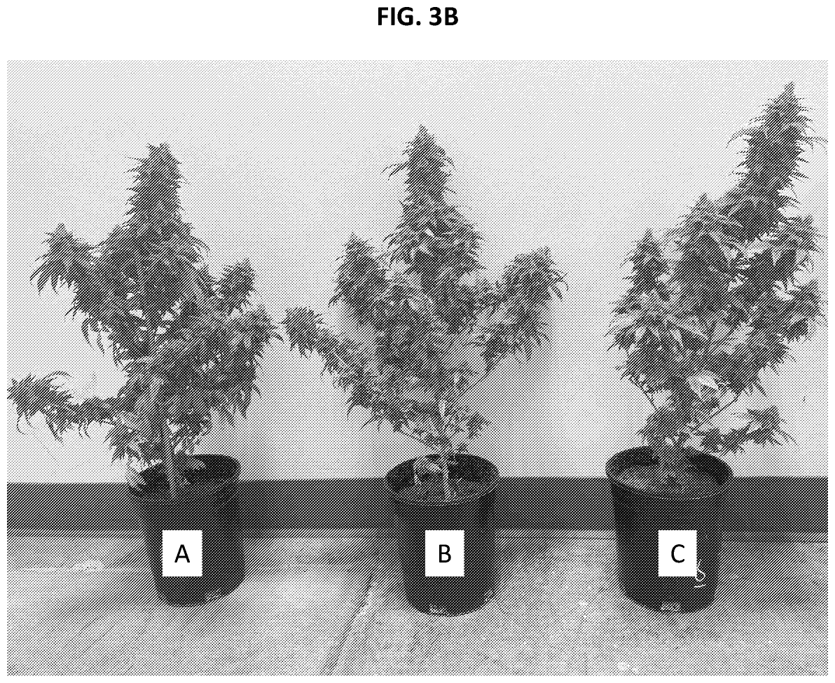

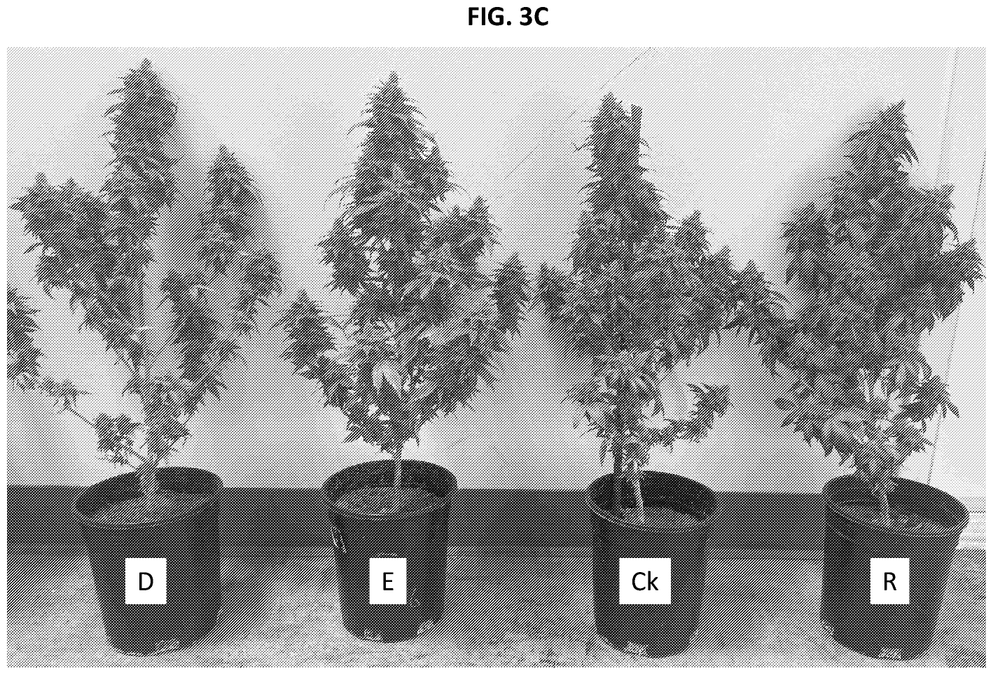

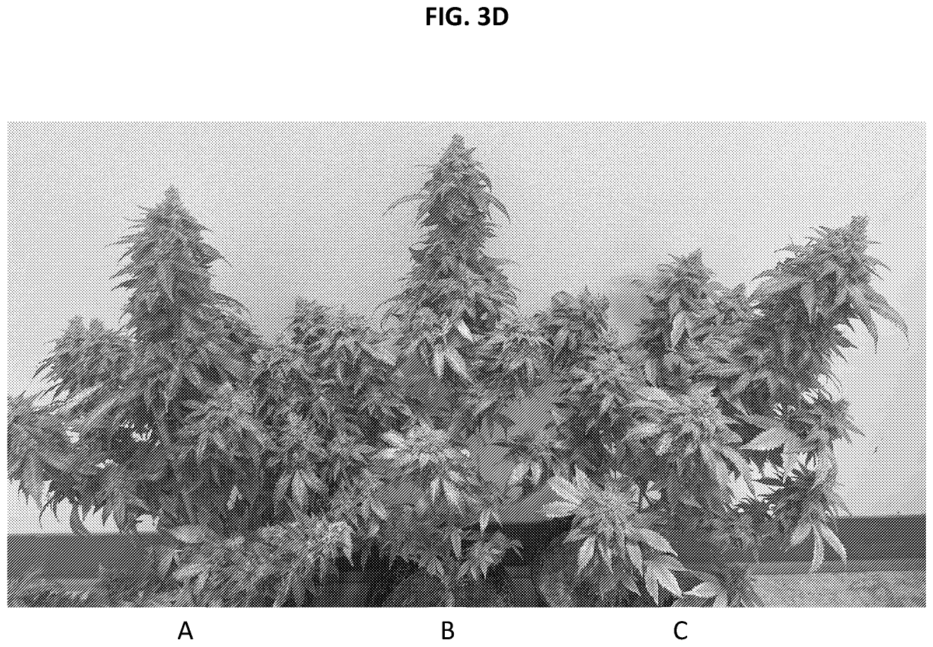

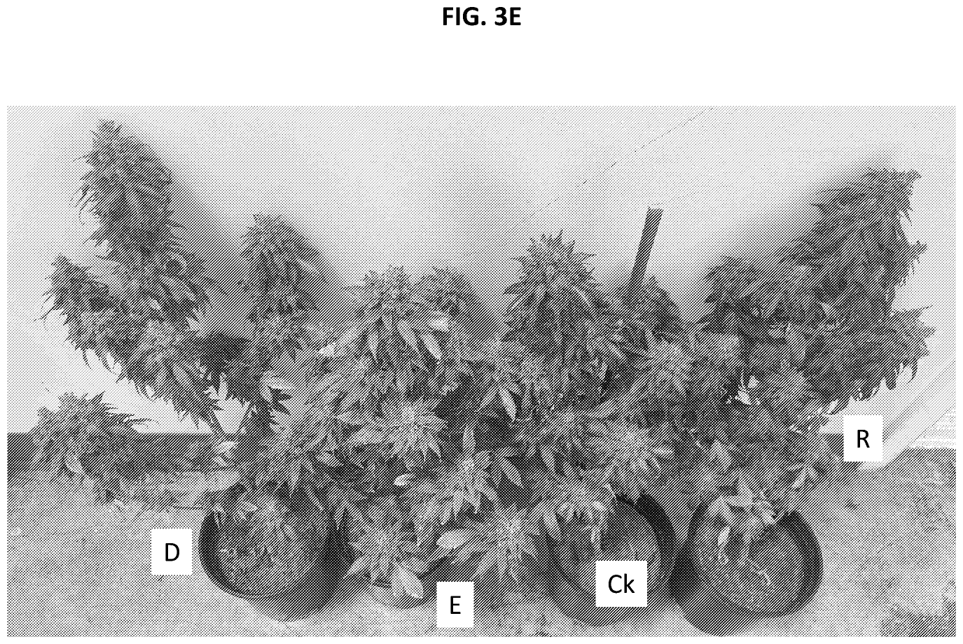

FIG. 2A-2C shows the results of above ground, belowground and total dry weight biomass measurements in grams for each treatment group. FIG. 3A-3E show images of the aerial biomass of plants from different treatment groups.

### Example 3: Consumer Trials in Cannabis

To test the effect of the combination of kelp and MDJ on secondary metabolite production in cannabis the following composition was tested on different cannabis strains.

TABLE 7
Composition of Concentrated and Dilute
Formulas for Consumer Trials

| | Dilute | | |
|---|---|---|---|
| | (ready-to-apply) | Concentrate | |
| MDJ | 0.23 μM-18.68 μM | 1.7675 | mM |
| Sorbitan monooleate | 0.022 μM-1.77 μM | 0.167 | mM |
| Polysorbate-20 | 0.86 nM-69.0 nM | 6.5 | μM |
| Kelp | 59.4450 μg/L-4.755 mg/L | 450 | mg/L |
| Potassium | 0.210 mM-16.798 mM | 1.59M | |
| Phosphorous | .198 mM-15.854 mM | 1.5010M | |
| Amino Acids | .00002%-.00159% | 0.15% | |
| Nitrogen | .0003 mM-0.022 mM | .0021M | |
| Hydrophobic Fulvic | 0.0000008%-0.0000634% | 0.0060% | |
| Acid | | | |

| | | |
|---|---|---|
| Ratio MDJ:Kelp | 1:1.1250 | 1:1.1250 |

Three consumers trialed the formula shown in Table 7 in different cannabis cultivars at concentrations between 0.5 mL/gal and 40 mL/gal.

Consumer #1 applied the composition as a root drench to cannabis cultivar ‘OL’ at a rate of 10 mL/gallon, with the first application being within the first week of flowering. A different cannabis quality-enhancement product was also used for comparison (Competitor) as was a water only control (Control).

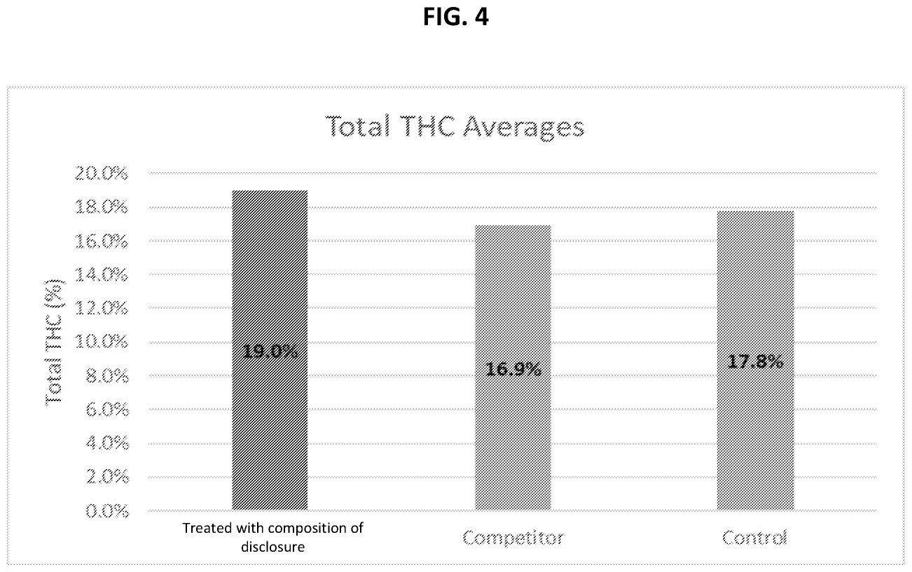

As shown in FIG. 4, plants that received the composition of the present disclosure exhibited 19% (mg/g) total THC, whereas plants that received a competing cannabis quality-enhancement product had 16.9% (mg/g) total THC. The control plants had 17.8% mg/g total THC.

Consumer #2 applied the composition to cannabis cultivar ‘Chem Dawg’ at a rate of 10 mL/gal, with the first application being 3 days post flower (Table 8). Plants were cloned on Jan. 18, 2022, with the vegetative phase starting on Feb. 7, 2022. Plants bloomed on Mar. 22, 2022, and were harvested on May 16, 2022.

TABLE 8
Application Rates and Dates for Consumer #2

| Application Dates | Application Rate | Day of Flower |
|---|---|---|
| Mar. 25, 2022 | 10 mL/gallon | 3 |
| Mar. 28, 2022 | 10 mL/gallon | 6 |
| Apr. 2, 2022 | 10 mL/gallon | 11 |
| Apr. 4, 2022 | 10 mL/gallon | 13 |
| Apr. 6, 2022 | 10 mL/gallon | 15 |
| Apr. 8, 2022 | 10 mL/gallon | 17 |
| Apr. 10, 2022 | 10 mL/gallon | 19 |
| Apr. 12, 2022 | 10 mL/gallon | 21 |
| Apr. 25, 2022 | 10 mL/gallon | 34 |
| Apr. 29, 2022 | 10 mL/gallon | 38 |
| May 3, 2022 | 10 mL/gallon | 42 |
| May 8, 2022 | 10 mL/gallon | 47 |

As shown in Table 9 below, plants that received the composition of present disclosure had 21.619% (mg/g) total THC, compared to 17.23% (mg/g) total THC in control plants. Total terpenes also increased from 1.272% in the control to 1.527 in the treated plants. LLOQ—less than limit of quantification.

TABLE 9
Consumer #2 Results

| | Treatment | |
|---|---|---|
| | Group | Control |
| Population: | 66 | 376 |
| Average Wet Weight per | 901.48 | 906.65 |
| Plant (g) | | |
| Average Dry Weight per | 148.9 | 108.7 |
| Plant (g) | | |

Cannabinoids

| | | |
|---|---|---|
| Total THC % | 21.619 | 17.23 |
| THCa % | 23.611 | 19.142 |
| d9-THC % | 0.912 | 0.443 |
| THCVa % | 0.146 | 0.107 |
| Total CBD % | 0.053 | 0.044 |
| CBDa % | 0.061 | 0.05 |
| CBGa % | 0.627 | 0.424 |
| CBNa % | 0.104 | 0.076 |

Terpenes

| | | |
|---|---|---|
| Total Terpenes % | 1.527 | 1.272 |
| Beta-Myrcene % | 0.6601 | 0.4355 |
| Beta-Caryophyllene % | 0.3642 | 0.408 |
| Beta-Pinene % | 0.0382 | LLOQ |
| D-Limonene % | 0.1324 | 0.0796 |
| Linalool % | 0.1012 | 0.0808 |
| Alpha-Humulene % | 0.1599 | 0.1809 |
| Alpha-(−)-Bisabolol % | 0.0280 | LLOQ |

Consumer #3 applied the composition to cannabis cultivar ‘Orange Kush Cake’ at a rate of 10 mL/gallon, with the first application being within the first week of flowering. A water only (Control) was also applied for comparison.

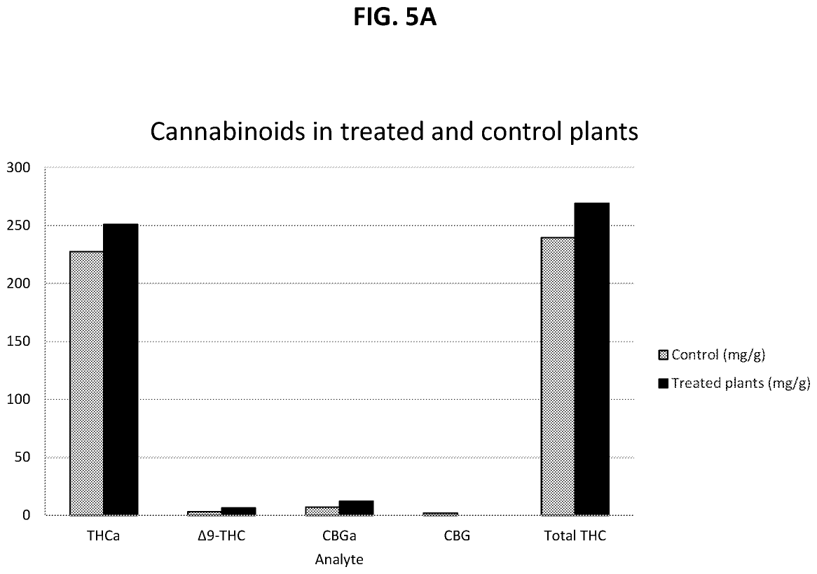

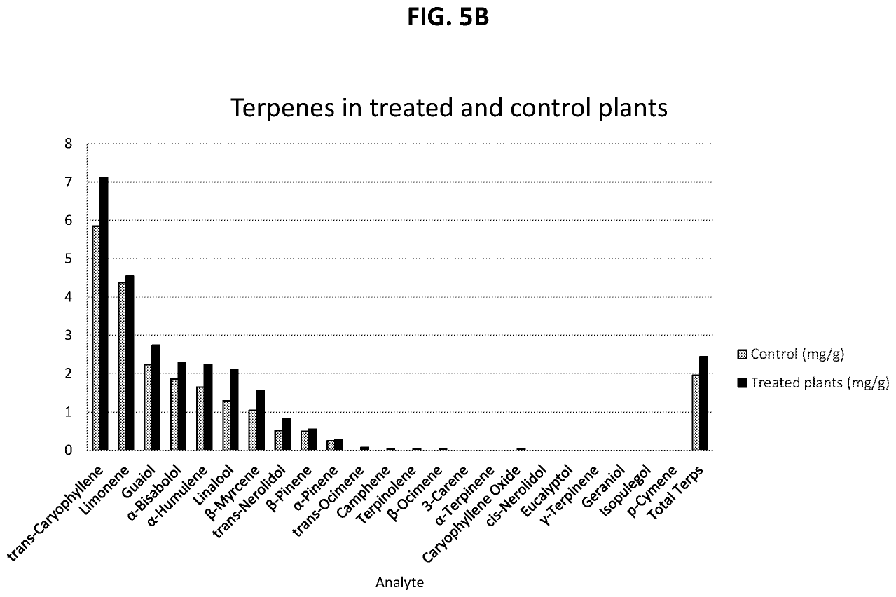

As shown in FIG. 5A, plants that received the composition of the present disclosure exhibited approximately 269 mg/g total THC, whereas the control plants had approximately 240 mg/g total THC. Individual and total terpenes were also increased in treated plants versus control plants (FIG. 5B).

### INCORPORATION BY REFERENCE

All references, articles, publications, patents, patent publications, and patent applications cited herein are incorporated by reference in their entireties for all purposes. US Published Application No. 2019/0059371 and PCT Published Application No. WO2022/026613 are also hereby incorporated by reference in their entirety. However, mention of any reference, article, publication, patent, patent publication, and patent application cited herein is not, and should not be taken as an acknowledgment or any form of suggestion that they constitute valid prior art or form part of the common general knowledge in any country in the world.

### NUMBERED EMBODIMENTS OF THE INVENTION

Notwithstanding the appended claims, the disclosure sets forth the following numbered embodiments:
1. An agricultural composition comprising:
   a jasmonate;
   an algae; and
   a surfactant.
2. The composition of embodiment 1, wherein the jasmonate is selected from the group consisting of methyl jasmonate, jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and analogues, isomers, derivatives or conjugates thereof.
3. The composition of embodiment 2, wherein the jasmonate is methyl dihydrojasmonate.
4. The composition of embodiment 3, wherein the weight ratio of methyl dihydrojasmonate to the algae is between about 1:1 and about 1:5.
5. The composition of embodiment 4, wherein the weight ratio of methyl dihydrojasmonate to the algae is between about 1:1 and 1:3.
6. The composition of embodiment 4, wherein the weight ratio of methyl dihydrojasmonate to the algae is between about 1:1 and 1:2.
7. The composition of any one of embodiments 1-6, wherein the composition comprises between about 0.1 μM and about 10 mM methyl dihydrojasmonate.
8. The composition of embodiment 7, wherein the composition comprises between about 0.1 μM and about 25 μM methyl dihydrojasmonate.
9. The composition of embodiment 7, wherein the composition comprises between about 1 and 10 mM jasmonate.
10. The composition of any one of embodiments 1-9, wherein the algae is brown seaweed.
11. The composition of any one of embodiments 1-10, wherein the algae is from the order Laminariales.
12. The composition of any one of embodiments 1-10, wherein the algae is selected from a species of Ascophyllum, Ecklonia, Fucus, Sargassum, and combinations thereof.
13. The composition of embodiment 12, wherein the algae comprises Ascophyllum nodosum.
14. The composition of any one of embodiments 1-13, wherein the composition comprises between about 1 μg/L and about 10 mg/L algae.
15. The composition of any one of embodiments 1-13, wherein the composition comprises between about 400 mg/L and 500 mg/L algae.
16. The composition of any one of embodiments 1-13, wherein the composition comprises about 450 mg/L algae.
17. The composition of any one of embodiments 1-16, wherein the surfactant is a non-ionic surface-active agent.
18. The composition of any one of embodiments 1-16, wherein the surfactant is polysorbate 20, sorbitan monooleate, or combinations thereof.
19. The composition of embodiment 18, wherein the weight ratio of methyl dihydrojasmonate to surfactant is between about 1:5 and 2:1.
20. The composition of any one of embodiments 1-19, wherein the composition further comprises at least one of nitrogen, phosphorous, potassium, and amino acids.
21. The composition of any one of embodiments 1-20, wherein the composition further comprises potassium.
22. The composition of any one of embodiments 1-20, wherein the composition comprises less than 11% (w/v) potassium.
23. The composition of any one of embodiments 1-20, wherein the composition comprises between about 100 μM and 50 mM potassium.
24. The composition of any one of embodiments 1-23, wherein the composition further comprises phosphorous.
25. The composition of any one of embodiments 1-23, wherein the composition comprises less than 9% (w/v) phosphorous.
26. The composition of any one of embodiments 1-23, wherein the composition comprises between about 100 μM and 25 mM phosphorous.
27. The composition of any one of embodiments 1-26, wherein the composition further comprises nitrogen.
28. The composition of any one of embodiments 1-26, wherein the composition comprises between about 0.1 μM and 100 μM supplemental nitrogen.
29. The composition of any one of embodiments 1-28, wherein the composition comprises monopotassium phosphate or dipotassium phosphate.
30. The composition of embodiment 29, wherein the composition comprises monopotassium phosphate.
31. The composition of any one of embodiments 1-30, wherein the composition further comprises amino acids.
32. The composition of any one of embodiments 1-30, wherein the composition comprises between about 0.00001% and 0.01% amino acids.
33. The composition of any one of embodiments 1-30, wherein the composition further comprises polypeptides.
34. The composition of any one of embodiments 1-30, wherein the composition comprises less than 2% (w/v) polypeptides.
35. The composition of any one of embodiments 1-34, wherein the composition further comprises a chelator.
36. The composition of embodiment 35, wherein the chelator is fulvic acid.
37. The composition of any one of embodiments 1-36, wherein the composition comprises less than 3% (w/v) fulvic acid.
38. The composition of any one of embodiments 1-37, wherein the composition comprises between about 5e-7% to about 3e-4% hydrophobic fulvic acid.
39. The composition of any one of embodiments 1-38, wherein the composition comprises:
   methyl dihydrojasmonate;
   Ascophyllum nodosum;
   a surfactant;
   potassium;
   phosphorous;
   amino acids;
   nitrogen; and
   fulvic acid.
40. The composition of any one of embodiments 1-39, wherein the composition comprises:
   between about 1 mM and 2 mM jasmonate; and
   between about 400 mg/L and 500 mg/L algae.
41. The composition of any one of embodiments 1-40, wherein the composition has a pH of between about 5 and about 9.
42. The composition of any one of embodiments 1-40, wherein the composition has a pH of about 6.5-7.5.
43. The composition of any one of embodiments 1-42, wherein the composition comprises potassium hydroxide.
44. The composition of embodiment 43, wherein the composition comprises between about 0.1 mM and 10 mM KOH.
45. A concentrated composition containing the same components and ratios of components as a composition according to any one of embodiments 1-44, concentrated between about 1.1 and about 10,000 fold.
46. A dilute composition containing the same components and ratios of components as a composition according to any one of embodiments 1-45, diluted between about 1.1 and about 10,000 fold.
47. A method for altering the production of one or more secondary metabolites in a Cannabis spp. plant or plant part, the method comprising: applying an effective amount of a composition according to any one of embodiments 1-46.
48. A method for altering the production of a terpene in a Cannabis spp. plant or plant part, the method comprising: applying an effective amount of a composition according to any one of embodiments 1-46.
49. A method for increasing a cannabinoid in a Cannabis spp. plant or plant part, the method comprising: applying an effective amount of a composition according to any one of embodiments 1-46.
50. A method for increasing resistance to an abiotic or biotic stressor in a Cannabis spp. plant or plant part, the method comprising: applying an effective amount of a composition according to any one of embodiments 1-46.
51. The method of any one of embodiments 47-50, wherein the composition is applied as a foliar spray.
52. The method of any one of embodiments 47-50, wherein the composition is applied as a root drench.
53. The composition of embodiment 45, wherein the concentrated composition is for application at an application rate of between about 0.5 and 5 gallons per acre.
54. The composition of embodiment 51, wherein the diluted composition is for application at an application rate of between about one-half inch and two inches per acre.
55. The composition of embodiment 51, wherein the diluted composition is for application at an application rate of between about one inch and two inches per acre.
56. The method of any one of embodiments 47-52, wherein the method comprises diluting a concentrated composition to between 0.5 mL/gal and 40 mL/gal and applying the dilution to a plant or plant part.
57. The method of any one of embodiments 47-52, wherein the composition is first applied before flower onset.
58. The method of any one of embodiments 47-52, wherein the composition is first applied after flower onset.
59. The method of any one of embodiments 47-52, wherein the composition is applied two or more times, thereby carrying out a plurality of applications.
60. The method of any one of embodiments 47-59, wherein the composition is applied two or more times, and wherein each application is separated by between 5-20 days.
61. The method of any one of embodiments 47-59, wherein the composition is applied at least two times separated by 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 days.
62. The method of any one of embodiments 47-61, wherein the composition is applied at least three times separated by 5-20 days.
63. The method of any one of embodiments 47-62, wherein the composition is applied about 24-72 hours prior to harvest.
64. The method of embodiment 49, wherein the cannabinoid is Δ9-Tetrahydrocannabinol (Δ9-THC), Δ9-Tetrahydrocannabinolic Acid (Δ9-THCA), Δ8-Tetrahydrocannabinol (Δ8-THC), Cannabichromene (CBC), Cannabicyclol (CBL), Cannabidiol (CBD), Cannabidiolic Acid (CBDA), Cannabielsoin (CBE), Cannabigerol (CBG), Cannabigerolic Acid (CBGA), Cannabinidiol (CBND), Cannabinol (CBN), Cannabitriol (CBT), cannabidivarin (CBDV), Δ9-Tetrahydrocannabivarin (THCV), cannabichromevarin (CBCV), or cannabigerovarin (CBGV).
65. The method of embodiment 49, wherein the cannabinoid is Cannabichromene (CBC), Cannabidiol (CBD), Cannabidiolic Acid (CBDA), cannabidivarin (CBDV), Cannabigerol (CBG), Cannabigerolic Acid (CBGA), Δ9-Tetrahydrocannabinol (Δ9-THC), Δ9-Tetrahydrocannabinolic Acid (Δ9-THCA).
66. The method of embodiment 48, wherein the terpene is α-pinene, camphene, β-pinene, myrcene, β-myrcene, α-phellandrene, carene, α-terpinene, limonene, β-ocimene, γ-terpinene, terpinolene, linalool, fenchol, α-terpineol, β-caryophyllene, α-humulene, caryophyllene oxide, nerolidol, guaiol, α-bisabolol, geraniol, α-cedrene, α-terpineol, endo-fenchyl, limonene, or trans-caryophyllene.
67. The method of embodiment 48, wherein the terpene is α-bisabolol, α-cedrene, α-humulene, α-pinene, α-terpineol, β-pinene, endo-fenchyl, limonene, or trans-caryophyllene.
68. The method of any one of embodiments 66-67, wherein the terpene is increased compared to an untreated Cannabis spp. plant or plant part.
69. The method of any one of embodiments 66-67, wherein the terpene is decreased compared to an untreated Cannabis spp. plant or plant part.
70. The method of any one of embodiments 47-69, wherein the Cannabis spp. plant or plant part is a high-THC variety.
71. The method of any one of embodiments 47-69, wherein the Cannabis spp. plant or plant part is a high-CBD variety.
72. The method of any one of embodiments 47-69, wherein the Cannabis spp. plant or plant part is a hemp variety.

1. An agricultural composition comprising:
a jasmonate;
an algae; and
a surfactant.

2. The composition of claim 1, wherein the jasmonate is selected from the group consisting of methyl jasmonate, jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and analogues, isomers, derivatives or conjugates thereof.

3. The composition of claim 2, wherein the jasmonate is methyl dihydrojasmonate.

4. The composition of claim 3, wherein the weight ratio of methyl dihydrojasmonate to the algae is between about 1:1 and about 1:5.

5. The composition of claim 3, wherein the weight ratio of methyl dihydrojasmonate to the algae is between about 1:1 and 1:3.

6. The composition of claim 3, wherein the weight ratio of methyl dihydrojasmonate to the algae is between about 1:1 and 1:2.

7. The composition of claim 3, wherein the composition comprises between about 0.1 μM and about 10 mM methyl dihydrojasmonate.

8. The composition of claim 3, wherein the composition comprises between about 0.1 μM and about 25 μM methyl dihydrojasmonate.

9. The composition of claim 1, wherein the composition comprises between about 1 and 10 mM jasmonate.

10. The composition of claim 1, wherein the algae is brown seaweed.

11. The composition of claim 1, wherein the algae is from the order Laminariales.

12. The composition of claim 1, wherein the algae is selected from a species of Ascophyllum, Ecklonia, Fucus, Sargassum, and combinations thereof.

13. The composition of claim 1, wherein the algae comprises Ascophyllum nodosum.

14. The composition of claim 1, wherein the composition comprises between about 1 μg/L and about 10 mg/L algae.

15. The composition of claim 1, wherein the composition comprises between about 400 mg/L and 500 mg/L algae.

16. The composition of claim 1, wherein the composition comprises about 450 mg/L algae.

17. The composition of claim 1, wherein the surfactant is a non-ionic surface-active agent.

18. The composition of claim 1, wherein the surfactant is polysorbate 20, sorbitan monooleate, or combinations thereof.

19. The composition of claim 18, wherein the weight ratio of methyl dihydrojasmonate to surfactant is between about 1:5 and 2:1.

20. The composition of claim 1, wherein the composition further comprises at least one of nitrogen, phosphorous, potassium, and amino acids.

21. The composition of claim 1, wherein the composition further comprises potassium.

22. The composition of claim 21, wherein the composition comprises less than 11% (w/v) potassium.

23. The composition of claim 21, wherein the composition comprises between about 100 μM and 50 mM potassium.

24. The composition of claim 1, wherein the composition further comprises phosphorous.

25. The composition of claim 24, wherein the composition comprises less than 9% (w/v) phosphorous.

26. The composition of claim 24, wherein the composition comprises between about 100 μM and 25 mM phosphorous.

27. The composition of claim 1, wherein the composition further comprises nitrogen.

28. The composition of claim 27, wherein the composition comprises between about 0.1 μM and 100 μM supplemental nitrogen.

29. The composition of claim 1, wherein the composition comprises monopotassium phosphate or dipotassium phosphate.

30. The composition of claim 29, wherein the composition comprises monopotassium phosphate.

31. The composition of claim 1, wherein the composition further comprises amino acids.

32. The composition of claim 31, wherein the composition comprises between about 0.00001% and 0.01% amino acids.

33. The composition of claim 1, wherein the composition further comprises polypeptides.

34. The composition of claim 33, wherein the composition comprises less than 2% (w/v) polypeptides.

35. The composition of claim 1, wherein the composition further comprises a chelator.

36. The composition of claim 35, wherein the chelator is fulvic acid.

37. The composition of claim 36, wherein the composition comprises less than 3% (w/v) fulvic acid.

38. The composition of claim 36, wherein the composition comprises between about 5e-7% to about 3e-4% hydrophobic fulvic acid.

39. The composition of claim 1, wherein the composition comprises:
methyl dihydrojasmonate;
Ascophyllum nodosum;
a surfactant;
potassium;
phosphorous;
amino acids;
nitrogen; and
fulvic acid.

40. The composition of claim 1, wherein the composition comprises:
between about 1 mM and 2 mM jasmonate; and
between about 400 mg/L and 500 mg/L algae.

41. The composition of claim 1, wherein the composition has a pH of between about 5 and about 9.

42. The composition of claim 1, wherein the composition has a pH of about 6.5-7.5.

43. The composition of claim 1, wherein the composition comprises potassium hydroxide.

44. The composition of claim 43, wherein the composition comprises between about 0.1 mM and 10 mM KOH.

45. A concentrated composition containing the same components and ratios of components as a composition according to any one of claims 1-44, concentrated between about 1.1 and about 10,000 fold.

46. A dilute composition containing the same components and ratios of components as a composition according to any one of claims 1-45, diluted between about 1.1 and about 10,000 fold.

47. A method for altering the production of one or more secondary metabolites in a Cannabis spp. plant or plant part, the method comprising: applying an effective amount of a composition according to claim 1.

48. A method for altering the production of a terpene in a Cannabis spp. plant or plant part, the method comprising: applying an effective amount of a composition according to claim 1.

49. A method for increasing a cannabinoid in a Cannabis spp. plant or plant part, the method comprising: applying an effective amount of a composition according to claim 1.

50. A method for increasing resistance to an abiotic or biotic stressor in a Cannabis spp. plant or plant part, the method comprising: applying an effective amount of a composition according to claim 1.

51. The method of any one of claims 47-50, wherein the composition is applied as a foliar spray.

52. The method of any one of claims 47-50, wherein the composition is applied as a root drench.

53. The composition of claim 45, wherein the concentrated composition is for application at an application rate of between about 0.5 and 5 gallons per acre.

54. The composition of claim 51, wherein the diluted composition is for application at an application rate of between about one-half inch and two inches per acre.

55. The composition of claim 51, wherein the diluted composition is for application at an application rate of between about one inch and two inches per acre.

56. The method of any one of claims 47-52, wherein the method comprises diluting a concentrated composition to between 0.5 mL/gal and 40 mL/gal and applying the dilution to a plant or plant part.

57. The method of any one of claims 47-52, wherein the composition is first applied before flower onset.

58. The method of any one of claims 47-52, wherein the composition is first applied after flower onset.

59. The method of any one of claims 47-52, wherein the composition is applied two or more times, thereby carrying out a plurality of applications.

60. The method of any one of claims 47-59, wherein the composition is applied two or more times, and wherein each application is separated by between 5-20 days.

61. The method of any one of claims 47-59, wherein the composition is applied at least two times separated by 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 days.

62. The method of any one of claims 47-61, wherein the composition is applied at least three times separated by 5-20 days.

63. The method of any one of claims 47-62, wherein the composition is applied about 24-72 hours prior to harvest.

64. The method of claim 49, wherein the cannabinoid is Δ9-Tetrahydrocannabinol (Δ9-THC), Δ9-Tetrahydrocannabinolic Acid (Δ9-THCA), Δ8-Tetrahydrocannabinol (Δ8-THC), Cannabichromene (CBC), Cannabicyclol (CBL), Cannabidiol (CBD), Cannabidiolic Acid (CBDA), Cannabielsoin (CBE), Cannabigerol (CBG), Cannabigerolic Acid (CBGA), Cannabinidiol (CBND), Cannabinol (CBN), Cannabitriol (CBT), cannabidivarin (CBDV), Δ9-Tetrahydrocannabivarin (THCV), cannabichromevarin (CBCV), or cannabigerovarin (CBGV).

65. The method of claim 49, wherein the cannabinoid is Cannabichromene (CBC), Cannabidiol (CBD), Cannabidiolic Acid (CBDA), cannabidivarin (CBDV), Cannabigerol (CBG), Cannabigerolic Acid (CBGA), Δ9-Tetrahydrocannabinol (Δ9-THC), Δ9-Tetrahydrocannabinolic Acid (Δ9-THCA).

66. The method of claim 48, wherein the terpene is α-pinene, camphene, β-pinene, myrcene, β-myrcene, α-phellandrene, carene, α-terpinene, limonene, β-ocimene, γ-terpinene, terpinolene, linalool, fenchol, α-terpineol, β-caryophyllene, α-humulene, caryophyllene oxide, nerolidol, guaiol, α-bisabolol, geraniol, α-cedrene, α-terpineol, endo-fenchyl, limonene, or trans-caryophyllene.

67. The method of claim 48, wherein the terpene is α-bisabolol, α-cedrene, α-humulene, α-pinene, α-terpineol, β-pinene, endo-fenchyl, limonene, or trans-caryophyllene.

68. The method of any one of claims 66-67, wherein the terpene is increased compared to an untreated Cannabis spp. plant or plant part.

69. The method of any one of claims 66-67, wherein the terpene is decreased compared to an untreated Cannabis spp. plant or plant part.

70. The method of any one of claims 47-69, wherein the Cannabis spp. plant or plant part is a high-THC variety.

71. The method of any one of claims 47-69, wherein the Cannabis spp. plant or plant part is a high-CBD variety.

72. The method of any one of claims 47-69, wherein the Cannabis spp. plant or plant part is a hemp variety.
